(19) United States
(12) Patent Application Publication
(10) Pub. No.: US 2026/0036697 A1
(43) Pub. Date: Feb. 5, 2026

(54) ELECTRONIC APPARATUS AND CONTROLLING METHOD THEREOF

(71) Applicant: Samsung Electronics Co., Ltd., Suwon-si (KR)

(72) Inventors: Taehee LEE, Suwon-si (KR); Taehyeong KIM, Suwon-si (KR)

(73) Assignee: Samsung Electronics Co., Ltd., Suwon-si (KR)

(21) Appl. No.: 19/289,753

(22) Filed: Aug. 4, 2025

Related U.S. Application Data
(63) Continuation of application No. PCT/KR2025/006166, filed on May 8, 2025.

(30) Foreign Application Priority Data
Aug. 2, 2024 (KR) 10-2024-0102913

(51) Int. Cl. G01S 17/894

(52) U.S. Cl. CPC G01S 17/894

(57) ABSTRACT

An electronic apparatus is disclosed. The electronic apparatus includes a LIDAR sensor, and at least one processor configured to (a) based on occurrence of a predetermined event, control the LiDAR sensor to sense a space with a sensing direction of the LiDAR sensor corresponding to a predetermined angle, so that the LiDAR sensor thereby obtains first sensing data, (b) after controlling the LiDAR sensor to sense the space with the sensing direction of the LIDAR sensor corresponding to the predetermined angle, control a sensing direction of the LiDAR sensor to be changed sequentially so that the LiDAR sensor thereby obtains a plurality of second sensing data respectfully corresponding to the sequentially changed sensing direction, and (c) obtain a depth map including distance information of the space based on the first sensing data and the plurality of second sensing data.

### CROSS-REFERENCE TO RELATED APPLICATIONS

This application is a continuation of International Application No. PCT/KR2025/006166 designating the United States, filed on May 8, 2025, in the Korean Intellectual Property Receiving Office and claiming priority to Korean Patent Application No. 10-2024-0102913, filed on Aug. 2, 2024, in the Korean Intellectual Property Office, the disclosures of each of which are incorporated by reference herein in their entireties.

### BACKGROUND

### Field

The disclosure relates to an electronic apparatus and a controlling method thereof, and more particularly, to an electronic apparatus that provides a depth map including distance information of a space, and a controlling method thereof.

### Description of Related Art

Spurred by the development of electronic technologies, various types of electronic apparatuses are being developed and distributed. In particular, projectors used in various places such as homes, offices, public spaces, etc. are continuously developing over the last few years.

Recently, a movable projector that can be used easily in various places is being provided. A movable projector can identify the ambient environment and obstacles by using a sensor in a projection space desired by the user, and search an appropriate projection surface.

### SUMMARY

The disclosure was devised for improving the aforementioned problem, and the purpose of the disclosure is in providing an electronic apparatus that obtains a depth map based on a plurality of sensing data sensed by a LiDAR sensor in a plurality of angles, and a controlling method thereof.

An electronic apparatus according to an embodiment of the disclosure may include a LiDAR sensor, and at least one processor. The at least one processor may (a) based on occurrence of a predetermined event, control the LiDAR sensor to sense a space with a sensing direction of the LiDAR sensor corresponding to a predetermined angle, so that the LiDAR sensor thereby obtains first sensing data, (b) after controlling the LiDAR sensor to sense the space with the sensing direction of the LiDAR sensor corresponding to the predetermined angle, control the sensing direction of the LiDAR sensor to be changed sequentially so that the LiDAR sensor thereby obtains a plurality of second sensing data respectfully corresponding to the sequentially changed sensing direction, and (c) obtain a depth map including distance information of the space based on the first sensing data and the plurality of second sensing data.

A controlling method of an electronic apparatus that includes a LiDAR sensor according to an embodiment of the disclosure may include (a) based on occurrence of a predetermined event, controlling the LiDAR sensor to sense a space with a sensing direction of the LiDAR sensor corresponding to a predetermined angle, so that the LiDAR sensor thereby obtains first sensing data, (b) after controlling the LiDAR sensor to sense the space with the sensing direction of the LiDAR sensor corresponding to the predetermined angle, controlling the sensing direction of the LiDAR sensor to be changed sequentially so that the LiDAR sensor thereby obtains a plurality of second sensing data respectively corresponding to the sequentially changed sensing direction, and (c) obtaining a depth map including distance information of the space based on the first sensing data and the plurality of second sensing data.

In a non-transitory computer-readable recording medium storing computer instructions which, when executed by a processor of an electronic apparatus that includes a LiDAR sensor, cause the electronic apparatus to perform operations according to an embodiment of the disclosure, the operations may include (a) based on occurrence of a predetermined event, controlling the LiDAR sensor to sense a space with a sensing direction of the LiDAR sensor corresponding to a predetermined angle, so that the LiDAR sensor thereby obtains first sensing data, (b) after controlling the LiDAR sensor to sense the space with the sending direction of the LiDAR sensor corresponding to the predetermined angle, controlling the sensing direction of the LiDAR sensor to be changed sequentially so that the LiDAR sensor thereby obtains a plurality of second sensing data respectively corresponding to the sequentially changed sensing direction, and (c) obtaining a depth map including distance information of the space based on the first sensing data and the plurality of second sensing data.

### BRIEF DESCRIPTION OF THE DRAWINGS

The aforementioned and other aspects, characteristics, and advantages of specific embodiments of the disclosure will become clearer from the following description with reference to the accompanying drawings.

FIG. 1 is a block diagram illustrating a configuration of an electronic apparatus according to at least one embodiment of the disclosure;

FIG. 2 is a diagram for illustrating an operation of obtaining a depth map based on a plurality of sensing data according to at least one embodiment of the disclosure;

FIG. 3 is a diagram for illustrating an operation of obtaining a depth map based on a plurality of sensing data according to at least one embodiment of the disclosure;

FIG. 4 is a diagram for illustrating an operation of an electronic apparatus according to at least one embodiment of the disclosure;

FIG. 5A is a diagram for illustrating an operation of obtaining a depth map according to at least one embodiment of the disclosure;

FIG. 5B is a diagram for illustrating an operation of obtaining a depth map according to at least one embodiment of the disclosure;

FIG. 6A is a diagram for illustrating an operation of obtaining information on a vanishing point according to at least one embodiment of the disclosure;

FIG. 6B is a diagram for illustrating an operation of obtaining information on a vanishing point according to at least one embodiment of the disclosure;

FIG. 7 is a diagram for illustrating an operation of updating distance information according to at least one embodiment of the disclosure;

FIG. 8A is a diagram for illustrating an operation of updating distance information according to at least one embodiment of the disclosure;

FIG. 8B is a diagram for illustrating an operation of updating distance information according to at least one embodiment of the disclosure;

FIG. 9 is a diagram for illustrating an operation of updating distance information according to at least one embodiment of the disclosure;

FIG. 10 is a diagram for illustrating an operation of updating distance information according to at least one embodiment of the disclosure;

FIG. 11 is a detailed block diagram for illustrating a detailed configuration of an electronic apparatus according to at least one embodiment of the disclosure;

FIG. 12 is a diagram for illustrating map information in a home according to at least one embodiment of the disclosure;

FIG. 13 is a diagram for illustrating map information in a home according to at least one embodiment of the disclosure; and

FIG. 14 is a flow chart for illustrating a controlling method of an electronic apparatus according to at least one embodiment of the disclosure.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, expressions such as “at least of A and B”, “at least one of A, and B”, “at least one of A and/or B”, “at least one of A, and/or B”, “at least one of A or B”, “at least one of A, or B”, and similar expressions, should be interpreted to include any of the following: A, B, A and B. Similarly, expressions such as “at least one of A, B and C”, “at least one of A, B, and C”, “at least one of A, B and/or C”, “at least one of A, B, and/or C”, “at least one of A, B or C”, “at least one of “A, B, or C”, and similar expressions, should be interpreted to include any of the following: A, B, C, A and B, A and C, B and C, A and B and C.

Further, the expressions “first,” “second” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. In addition, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor, except “a module” or “a part” that needs to be implemented as specific hardware.

Also, in this specification, the term “user” may refer to a person who uses an electronic apparatus or an apparatus using an electronic apparatus (e.g.: an artificial intelligence electronic apparatus).

Hereinafter, an embodiment of the disclosure will be described in more detail with reference to the accompanying drawings.

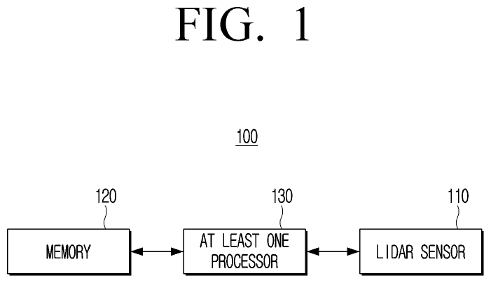

FIG. 1 is a block diagram illustrating a configuration of an electronic apparatus according to at least one embodiment of the disclosure.

According to FIG. 1, an electronic apparatus 100 may include a LiDAR sensor 110, memory 120, and at least one processor 130.

The electronic apparatus 100 according to various embodiments of the disclosure may include, for example, at least one of a smartphone, a tablet PC, a desktop PC, a laptop PC, or a wearable device. A wearable device may include at least one of an accessory-type device (e.g.: a watch, a ring, a bracelet, an ankle bracelet, a necklace, glasses, a contact lens, or a head-mounted-device (HMD)), a device integrated with fabrics or clothing (e.g.: electronic clothing), a body-attached device (e.g.: a skin pad or a tattoo), or an implantable circuit.

Also, in some embodiments, the electronic apparatus may include, for example, at least one of a television, a digital video disk (DVD) player, an audio, a refrigerator, an air conditioner, a cleaner, an oven, a microwave oven, a washing machine, an air purifier, a set top box, a home automation control panel, a security control panel, a media box (e.g.: Samsung HomeSync™, Apple TV™, or Google TV™), a game console (e.g.: Xbox™, PlayStation™), an electronic dictionary, an electronic key, a camcorder, or an electronic photo frame. Meanwhile, among the aforementioned electronic apparatuses, an apparatus including a display may be referred to as a display apparatus. Meanwhile, the electronic apparatus according to the disclosure may be a set top box or a PC that provides images to a display apparatus even though it does not include a display.

According to an embodiment of the disclosure, the electronic apparatus 100 can be implemented as a projector that projects images on a wall or a screen, or various types of apparatuses equipped with an image projection function. Hereinafter, operations of the electronic apparatus 100 will be explained by assuming that the electronic apparatus 100 is implemented as an apparatus equipped with an image projection function.

In case the electronic apparatus 100 is implemented as an apparatus equipped with an image projection function, the electronic apparatus 100 may sense an ambient space for projecting an image for identifying a projection surface for projecting an image, and obtain a depth map (or it may be referred to as ‘a 3D Time-of-Flight (ToF) depth map’ or ‘a 3D ToF image’) including distance information.

According to an embodiment, the electronic apparatus 100 may sense an ambient space through the LiDAR sensor 110 located on one side of the electronic apparatus 100, and obtain a depth map. Also, according to an embodiment, the LiDAR sensor 110 may be located in various locations of the electronic apparatus 100. For example, the LiDAR sensor 110 may be located in the upper part of the electronic apparatus 100. For example, in case the electronic apparatus 100 is implemented as a movable projector (or a mobile robot) of a spherical shape (a ball shape), the LiDAR sensor may be located in the upper part of the head of the movable projector.

The LiDAR sensor 110 may identify a distance between the LiDAR sensor and an object based on a difference between the phase of a light output from the light emitting part of the LiDAR sensor 110 and a phase of a light received at the light receiving part. For example, the light receiving part may be implemented as a Time-of-Flight (ToF) sensor, and hereinafter, explanation will be described by assuming that the light receiving part is implemented as a ToF sensor.

The LiDAR sensor 110 according to an embodiment of the disclosure may include a light emitting part, a ToF sensor, and a driving part. Meanwhile, the LiDAR sensor 110 does not necessarily have to be implemented to include all of the aforementioned components, but may be implemented while some components are omitted or new components are added.

The light emitting part emits a modulated light toward an object around the LiDAR sensor 110. Here, the modulated light (referred to as an output light hereinafter) output from the light emitting part may have a wave form in a form of a square wave or a wave form in a form of a sinusoidal wave.

According to an embodiment of the disclosure, the light emitting part may output lights of various frequency bands. Specifically, the light emitting part may sequentially output lights of different frequency bands. Here, outputting lights sequentially means that the light emitting part outputs lights by a predetermined interval, and as an example, the light emitting part may output a light of 5 MHz, and then sequentially output a light of 100 MHz. Alternatively, the light emitting part may output lights of different frequency bands according to driving of the LiDAR sensor.

The ToF sensor obtains a light reflected by an object (referred to as a reflective light hereinafter). Specifically, the ToF sensor receives a reflective light that is output from the light emitting part, and is then reflected by an object and returns toward the LiDAR sensor.

The ToF sensor may be implemented as an indirect ToF (iToF) sensor. The iToF sensor may identify a difference between a phase of a received reflective light and a phase of an output light output from the light emitting part, and then obtain a phase difference. The ToF sensor may be implemented as other ToF sensors (e.g.: a direct ToF (dToF) sensor). However, the ToF sensor is not limited thereto, and it may be implemented as various types of ToF sensors.

According to an embodiment, in case the ToF sensor is implemented as an iToF sensor, the ToF sensor may be connected with the light emitting part, and obtain phase information of an output light output from the light emitting part. Then, based on the obtained phase information, the ToF sensor may identify a difference between the phase of the output light output from the light emitting part and the phase of the received reflective light.

According to an embodiment, the LiDAR sensor 110 may include a driving part. Specifically, the driving part is a component for rotating the LiDAR sensor 110. The driving part may rotate the LiDAR sensor 110 by 360 degrees by a predetermined rotation speed. For this, the driving part may be implemented as a motor.

As the LiDAR sensor 110 rotates in 360 degrees, the light emitting part may output a light by a predetermined time interval and scan the ambient environment in 360 degrees, and the LiDAR sensor 110 may generate a 3D point cloud based on the scan result.

According to an embodiment, an encoder connected with the driving part may record a rotation angle on every time point of outputting a light. Here, the encoder may be a device for detecting information such as a rotation speed of the motor, an angle, and a direction, etc. A rotation angle recorded by the encoder may mean an angle between a direction in which the light emitting part of the LiDAR sensor 110 output a light and a reference direction. For example, the reference direction may be determined based on an angle corresponding to a direction when the encoder is turned on, an angle corresponding to a predetermined direction at the LiDAR sensor 110, etc.

According to an embodiment, the ToF sensor may sequentially receive a reflective light, and sequentially identify a difference between a phase of a reflective light and a phase of an output light.

According to an embodiment, the electronic apparatus 100 may obtain a plurality of rotation angles identified by the encoder, and obtain phase differences corresponding to each of the plurality of rotation angles from the ToF sensor.

In the memory 120, various kinds of sensing data obtained at the LiDAR sensor 110 and at least one instruction regarding the electronic apparatus 100 may be stored. The memory 120 may store various kinds of intermediate data that is used in the midway while the electronic apparatus 100 obtains a depth map including distance information.

The memory 120 may be implemented as internal memory such as ROM (e.g., electrically erasable programmable read-only memory (EEPROM)), RAM, etc., included in the at least one processor 130, or implemented as separate memory from the at least one processor 130. In this case, the memory 120 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

In the case of memory embedded in the electronic apparatus 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

In the memory 120, an operating system (O/S) for driving the electronic apparatus 100 may be stored. In addition, in the memory 120, various kinds of software programs or applications for the electronic apparatus 100 to operate according to the various embodiments of the disclosure may be stored. Further, the memory 120 may include semiconductor memory such as flash memory or a magnetic storage medium such as a hard disk, etc.

Specifically, in the memory 120, various kinds of software modules for the electronic apparatus 100 to operate according to the various embodiments of the disclosure may be stored, and the at least one processor 130 may control the operations of the electronic apparatus 100 by executing the various kinds of software modules stored in the memory 120. That is, the memory 120 may be accessed by the at least one processor 130, and reading/recording/correction/deletion/update, etc. of data by the at least one processor 130 may be performed.

In the disclosure, the term memory 120 may be used as a meaning including a storage part, ROM and RAM inside the at least one processor 130, or a memory card (e.g., a micro SD card, a memory stick) installed on the electronic apparatus 100.

The at least one processor 130 may be connected with the memory 120 and the LiDAR sensor 110, and perform various functions or instructions of the electronic apparatus 100.

The at least one processor 130 may perform the operations of the electronic apparatus 100 according to the various embodiments by executing the at least one instruction stored in the memory 120.

The at least one processor 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 130 may control one or a random combination of the other components of the electronic apparatus, and perform an operation related to communication or data processing. Also, the at least one processor 130 may execute one or more programs or instructions stored in the memory. For example, the at least one processor 130 may perform the method according to an embodiment of the disclosure by executing one or more instructions stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 130 may be implemented as a single core processor including one core, or may be implemented as one or more multicore processors including a plurality of cores (e.g., multicores of the same kind or multicores of different kinds). In case the at least one processor 130 is implemented as multicore processors, each of the plurality of cores included in the multicore processors may include internal memory of the processor such as cache memory, on-chip memory, etc., and common cache shared by the plurality of cores may be included in the multicore processors.

In the embodiments of the disclosure, the processor may mean a system on chip (SoC) wherein the at least one processor 130 and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

Meanwhile, the processor 130 may perform the various operations of the disclosure by using an artificial intelligence model. An artificial intelligence model is a computer system or a software module for implementing intelligence of a human level, and is characterized in that a machine learns and determines by itself, and shows a more improved recognition rate as it is used more.

An artificial intelligence model consists of machine learning (deep learning) technologies using an algorithm that classifies/learns the characteristics of input data by itself, and element technologies of simulating functions of a human brain such as cognition and determination by using a machine learning algorithm.

Element technologies may include at least one of, for example, a linguistic understanding technology of recognizing languages/characters of humans, a visual understanding technology of recognizing an object in a similar manner to human vision, an inference/prediction technology of determining information and then making logical inference and prediction, or a knowledge representation technology of processing information of human experiences into knowledge data.

The artificial intelligence model in the disclosure may perform, by execution by the at least one processor 130, an operation of logically inferring and predicting a depth map including distance information of a space according to sensing data based on pre-stored data, an operation of analyzing sensing data, etc., and identifying a depth map through the analysis result and inference based on probabilities according to the use histories, etc.

Such various operations of the artificial intelligence model according to the disclosure may be performed by the processor 130 and the memory 120.

The processor 130 may consist of one or a plurality of processors. As described above, the processor 130 may be implemented in various forms, but in particular, the one or plurality of processors may also be implemented as artificial intelligence-dedicated processors. An artificial intelligence-dedicated processor may be designed as a hardware structure specified for processing of a specific artificial intelligence model.

Meanwhile, the artificial intelligence model may be stored in the memory 120. Also, the artificial intelligence model may be made through learning.

Being made through learning means that a basic artificial intelligence model is trained by using a plurality of training data by a learning algorithm, and predefined operation rules or an artificial intelligence model set to perform a desired characteristic (or, purpose) is thereby made. Such learning may be performed in the electronic apparatus 100 itself wherein artificial intelligence is performed according to the disclosure, or performed through a separate server and/or system. As examples of learning algorithms, there are supervised learning, unsupervised learning, semi-supervised learning, or reinforcement learning, but learning algorithms are not limited to the aforementioned examples.

An artificial intelligence model may consist of a plurality of neural network layers. Each of the plurality of neural network layers has a plurality of weight values, and performs a neural network operation through the operation result of the previous layer and an operation among the plurality of weight values. The plurality of weight values included by the plurality of neural network layers may be optimized by the learning result of the artificial intelligence model. For example, the plurality of weight values may be updated such that a loss value or a cost value obtained in the artificial intelligence model during a learning process is reduced or minimized.

An artificial neural network may include a deep neural network (DNN), and there are, for example, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial network (GAN), or deep Q-networks, etc., but the disclosure is not limited to the aforementioned examples.

In the various embodiments of the disclosure, a depth map obtained based on distance information of a space may be obtained according to a result of going through inference and prediction processes by utilizing an artificial intelligence model. Inference/prediction refers to a technology of determining information and then making logical inference and prediction, and includes knowledge/probability based inference, optimization prediction, preference based planning, recommendation, and the like. According to the various embodiments of the disclosure, the at least one processor 130 (referred to as the processor hereinafter) may obtain a depth map by using the artificial intelligence model.

According to an embodiment, the processor 130 may obtain a depth map including distance information of a space by using a plurality of sensing data stored in the memory 120.

According to an embodiment, the processor 130 may control the LiDAR sensor 110 to sense a space with a sensing direction of the LiDAR sensor 110 corresponding to a predetermined angle, according to a predetermined event. Here, the angle may correspond to an angle constituted with respect to the ground. For example, the predetermined event may include an event wherein the electronic apparatus 100 is turned on.

As an example, the predetermined event may correspond to an event wherein the electronic apparatus 100 is activated to sense a space through the LiDAR sensor 110 after being turned on. That is, in case the electronic apparatus 100 is set as a power saving state after being turned on, the processor 130 may not sense a space with a sensing direction of the LiDAR sensor corresponding to the predetermined angle. In contrast, in case the electronic apparatus 100 is activated to sense a space but is not set as a power saving state after being turned on, the electronic apparatus 100 may sense a space with the sensing direction of the LiDAR sensor corresponding to the predetermined angle. Operations after the electronic apparatus 100 sensed a space with the sensing direction of the LiDAR sensor corresponding to the predetermined angle according to an event wherein the electronic apparatus 100 is activated to sense a space will be described in detail in the parts below.

According to an embodiment, when the electronic apparatus 100 is activated to sense a space, the LiDAR sensor 110 may sense a space with the sensing direction of the LiDAR sensor 110 corresponding to a parallel angle with the ground. For example, in case the LiDAR sensor 110 is located in the upper part of the electronic apparatus 100, the LiDAR sensor 110 may emit a light in a horizontal direction with respect to the ground. For example, if the electronic apparatus 100 is activated to sense a space, the processor 130 may control the LiDAR sensor 110 to start sensing at the same time as the electronic apparatus 100 being activated to sense a space, instead of starting sensing after adjusting the sensing direction of the LiDAR sensor 110. Accordingly, the LiDAR sensor 110 can start sensing from a space with the sensing direction corresponding to a parallel angle with the ground.

According to an embodiment, the processor 130 may obtain first sensing data that was obtained through the LiDAR sensor 110 according to a predetermined event, and store the data in the memory 120. For example, the processor 130 may obtain the first sensing data that was obtained as the LiDAR sensor 110 sensed a space with the sensing direction of the LiDAR sensor 110 corresponding to a parallel angle with the ground, and store the data in the memory 120.

According to an embodiment, after a space is sensed with the sensing direction corresponding to a parallel angle with the ground, the processor 130 may store a plurality of second sensing data that was obtained by controlling the sensing direction of the LiDAR sensor 110 to be changed sequentially in the memory 120.

According to an embodiment, the processor 130 may control the sensing direction to be changed sequentially in the upper direction while the LiDAR sensor 110 is toward a parallel direction with the ground, and obtain the plurality of second sensing data through the LiDAR sensor 110. However, the disclosure is not limited thereto, and the processor 130 may control the sensing direction to be changed sequentially in the lower direction while the LiDAR sensor 110 is toward a parallel direction with the ground, and obtain the plurality of second sensing data through the LiDAR sensor 110. For example, in case the electronic apparatus 100 is implemented as a movable apparatus, the electronic apparatus 100 may be located on an object (e.g., furniture) spaced from the ground by a predetermined distance, but not the ground. In this case, the electronic apparatus 100 may identify the distance spaced from the ground by using various sensors, and control the LiDAR sensor 110 to change the sensing direction sequentially to the lower direction while being toward a parallel direction with the ground according to the identified distance.

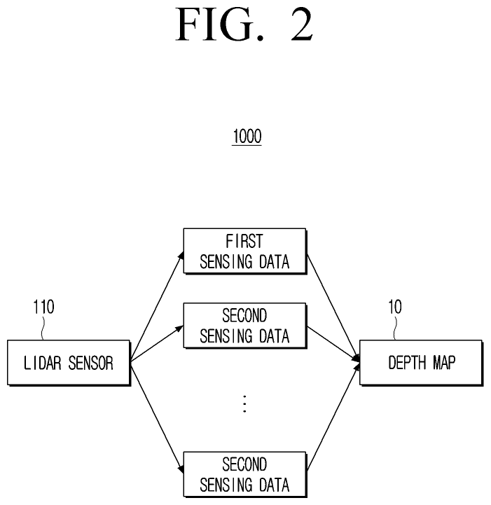

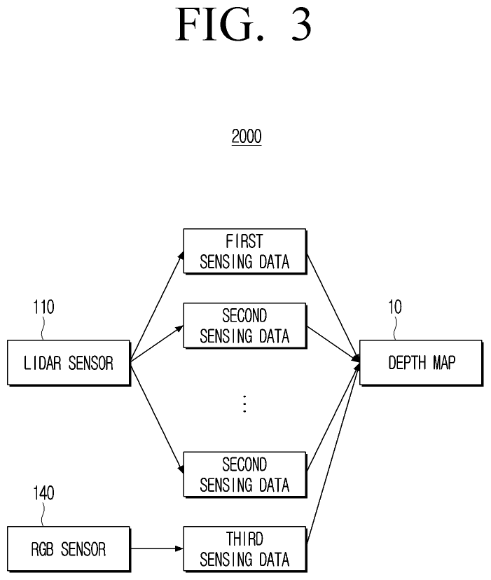

According to an embodiment, the processor 130 may obtain a depth map including distance information of a space based on the first sensing data and the plurality of second sensing data. The depth map may be information including information indicating the distance between each pixel and the LiDAR sensor 110. For example, the depth map may be in a form wherein each pixel has a distance value. For example, a distance value may be expressed as a grayscale, and the brightness of a specific pixel may indicate a distance between the pixel and the LiDAR sensor 110. However, the disclosure is not limited thereto, and a distance value may be expressed as at least one of a floating point, a digital distance code, or a bit number. The depth map may be implemented in a form of a 2D point cloud. Here, the point cloud is a gathering of points indicating each point in a 3D space, and may be implemented in a form wherein a plurality of points are arranged for each row. FIG. 2 and FIG. 3 are diagrams for illustrating an operation of obtaining a depth map based on a plurality of sensing data according to at least one embodiment of the disclosure.

According to FIG. 2, a process 1000 wherein the processor 130 obtains a depth map 10 including distance information of a space based on the first sensing data and the second sensing data is illustrated.

According to an embodiment, the space may be at least a partial space of the ambient space of the location wherein the electronic apparatus 100 is located. The ambient space may be a space in 360 degrees around the electronic apparatus 100 of which radius is a distance wherein sensing is possible with the electronic apparatus 100 as the center. For example, the distance wherein sensing is possible means a distance that can be sensed by the electronic apparatus 100 through the LiDAR sensor 110, and may be a predetermined distance from the LiDAR sensor 110. However, the distance wherein sensing is possible may be implemented in various ways according to the performance of each of the light emitting part and the ToF sensor of the LiDAR sensor 110.

According to an embodiment, the electronic apparatus 100 may identify whether a specific space in the ambient space is an area wherein projection is possible. For example, an area wherein projection is possible may mean an area wherein it is appropriate for the electronic apparatus 100 to project an image.

For example, the processor 130 may obtain a depth map corresponding to a space, and identify whether the space is an area wherein projection is possible based on the obtained depth map.

As an example, if it is identified that a set space is not an area wherein projection is possible, the processor 130 may reset an adjacent space or other spaces (e.g., a space spaced from the set space by a predetermined distance) as a space, and identify whether the reset space is an area wherein projection is possible. According to an embodiment, the processor 130 may obtain the first sensing and the plurality of second sensing data through the LiDAR sensor 110.

For example, the first sensing and the plurality of second sensing data may be data obtained by sensing a space in different directions as described above. For example, each of the first sensing data and the second sensing data may include a rotation angle and a difference between a phase of a received reflective light and a phase of an output light.

The processor 130 may identify a distance value for the space based on this phase difference. Here, the distance value may be a distance value between the LiDAR sensor and an object identified by the ToF sensor. The distance value may also be referred to as a distance, a depth, or a depth value, etc.

However, the disclosure is not limited thereto, and in case the LiDAR sensor 110 includes a dToF sensor, the distance value may be a time consumed for a light output from the LiDAR sensor 110 to be received at the dToF sensor. In this case, the processor 130 may identify the distance value for the space based on the consumed time.

The processor 130 may obtain the depth map 10 including distance information of the space based on the identified distance value.

Meanwhile, the processor 130 may obtain the depth map 10 also based on different types of sensing data other than the first sensing data and the second sensing data.

According to FIG. 3, a process 2000 wherein the processor 130 obtains the depth map 10 including distance information of a space based on the first sensing data, the second sensing data, and the third sensing data is illustrated.

The processor 130 may obtain the third sensing data through an RGB sensor 140. The RGB sensor 140 may be a sensor that detects three basic colors of red, green, and blue, and generates a color image.

As an example, the RGB sensor 140 may be implemented as a camera. Here, the camera is a device that can photograph a still image and a moving image, and may include at least one image sensor (e.g., a front surface sensor or a rear surface sensor), a lens, an image signal processor (ISP), and a flash (e.g., LED, a xenon lamp, etc.).

According to an embodiment, the RGB sensor 140 may photograph any object according to control by the processor 130, and transmit the photographed data to the processor 130. The photographed data can obviously be stored in the memory 120 according to control by the processor 130. Here, the photographed data may be referred to by various names such as a picture, an image, a still image, a moving image, etc., but it will be generally referred to as an image for the convenience of explanation. Meanwhile, it is obvious that an image according to the various embodiments of the disclosure can mean an image received from an external apparatus or an external server, an image stored in the memory 120, etc. other than a live view image photographed through the camera.

The processor 130 may obtain a color image of an environment around the electronic apparatus 100 through the RGB sensor 140. That is, the processor 130 may obtain the obtained color image as the third sensing data.

Here, the third sensing data may indicate a plurality of object areas. Here, the plurality of objects may mean a plurality of objects that the electronic apparatus 100 recognized to exist in the space around the electronic apparatus 100. Also, here, the plurality of objects may mean areas occupied by each object in a plurality of object segmentation images. Here, the segmentation images are images obtained by performing RGB segmentation (referred to as segmentation hereinafter) for an RGB image obtained by the RGB sensor. For example, segmentation may be a process of analyzing pixels included in an RGB image, and identifying and separating a plurality of objects through the LiDAR sensor 110.

The processor 130 may obtain the depth map 10 by using both of the LiDAR sensor 110 and the RGB sensor 140. That is, the processor 130 may obtain the depth map 10 including distance information of a space based on the first sensing data and the plurality of second sensing data obtained through the LiDAR sensor 110, and the third sensing data obtained through the RGB sensor 140.

The processor 130 may also obtain the depth map 10 based on other sensing data. Here, the other sensing data may correspond to sensing data obtained by other sensors mounted on the electronic apparatus 100 (e.g.: an illumination sensor, a distance sensor, a bio information sensor, an acceleration sensor, etc.) other than the LiDAR sensor 110 and the RGB sensor 140. Hereinafter, an operation of the electronic apparatus 100 of obtaining the depth map 10 will be described in detail.

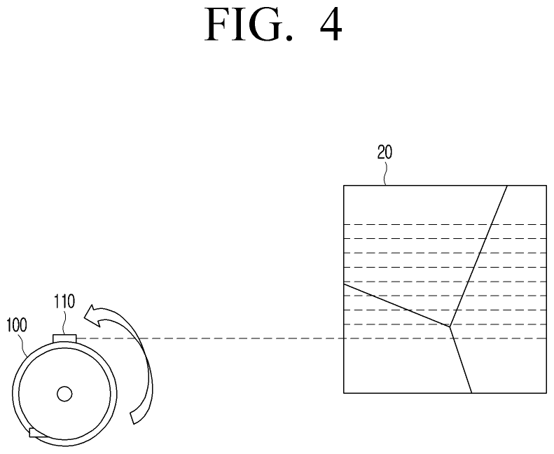

FIG. 4 is a diagram for illustrating an operation of an electronic apparatus according to at least one embodiment of the disclosure.

According to FIG. 4, the electronic apparatus 100 may include a LiDAR sensor 110, and sense a space 20 through the LiDAR sensor 110.

The electronic apparatus 100 may be an electronic apparatus 100 having an outer appearance as illustrated in FIG. 4, but is not limited thereto.

The LiDAR sensor 110 may be a sensor having an outer appearance as illustrated in FIG. 4, but is not limited thereto.

The electronic apparatus 100 may sense the space 20 by each of a plurality of lines. Here, the plurality of lines may correspond to a plurality of sensing directions. The lowest line among the plurality of lines may correspond to a line through which the electronic apparatus 100 senses a space with a sensing direction of the LiDAR sensor 110 corresponding to a predetermined angle.

Specifically, the electronic apparatus 100 may, based on occurrence of a predetermined event, control the LiDAR sensor 110 to sense a space with a sensing direction corresponding to a predetermined angle so that the LiDAR sensor thereby obtains the first sensing, and the electronic apparatus 100 may store the data in the memory 120.

The electronic apparatus 100 may identify whether a predetermined event occurs.

Here, the predetermined event is an event for the electronic apparatus 100 to sense a space.

As an example, the predetermined event may be an activation of the electronic apparatus 100 to sense a space. Specifically, based on the occurrence of the predetermined event which is an activation of the electronic apparatus 100 to sense a space, the electronic apparatus 100 may control the LiDAR sensor 110 to sense the space with the sensing direction of the LiDAR sensor 110 corresponding to a predetermined angle, which may be a parallel angle with the ground based on a direction which the LiDAR sensor 110 is toward, so that the LiDAR sensor 110 thereby obtains the first sensing data.

According to an embodiment, if the electronic apparatus 100 receives a signal of an external apparatus, an event wherein the electronic apparatus 100 is activated to sense a space may occur. For example, if the electronic apparatus 100 receives a signal requesting to transmit sensing data from an external apparatus, the electronic apparatus 100 may be activated to sense a space. Alternatively, if the electronic apparatus 100 receives a signal requesting to transmit distance information obtained by the electronic apparatus 100 from an external apparatus, the electronic apparatus 100 may be activated to sense a space.

According to an embodiment, if the electronic apparatus 100 receives a user input for obtaining sensing data, the electronic apparatus 100 may be activated to sense a space. However, the disclosure is not limited thereto.

If the electronic apparatus 100 identifies that a predetermined event occurs, the electronic apparatus 100 may control the LiDAR sensor 110 to sense a space with a sensing direction of the LiDAR sensor 110 corresponding to a predetermined angle.

Here, the predetermined angle is an angle that the LiDAR sensor 110 initially senses for a space after a predetermined event occurs. Here, the angle may be an angle based on the ground.

As an example, the predetermined angle may be a parallel angle with the ground. In this case, if the electronic apparatus 100 identifies that a predetermined event occurs, the electronic apparatus 100 may control the LiDAR sensor 110 to sense a space with a sensing direction corresponding to a parallel angle with the ground.

As an example, the predetermined angle may be set as various angles according to the geography of the space where the electronic apparatus 100 is located. For example, in case the electronic apparatus 100 is located on a slope of a specific angle, the predetermined angle may be an angle parallel to a plain located under the slope. In this case, the electronic apparatus 100 may control the LiDAR sensor 110 to sense a space with a sensing direction corresponding to a parallel angle with the plain but not a parallel angle with the slope.

However, the predetermined angle is not limited to the above example, and the predetermined angle may be set as various angles according to the user setting.

The electronic apparatus 100 may control the LiDAR sensor 110 and obtain the first sensing data through the LiDAR sensor 110, and store the data in the memory 120.

The first sensing data may be data that the LiDAR sensor 110 obtained by sensing the surroundings of the electronic apparatus 100 omnidirectionally in 360 degrees. In this case, the electronic apparatus 100 may obtain sensing data regarding the ambient space of the electronic apparatus 100 in directions of 360 degrees around the electronic apparatus 100.

After the electronic apparatus 100 obtains the first sensing data and stores the data in the memory 120, the electronic apparatus 100 may control the LiDAR sensor 110 to change the sensing direction of the LiDAR sensor 110 sequentially.

Here, the sensing direction of the LiDAR sensor 110 may mean an up to down direction in which the LiDAR sensor 110 senses a space.

In case the electronic apparatus 100 cannot change the direction of the LiDAR sensor 110 separately from the electronic apparatus 100, a vertical sensing direction may coincide with the direction which the front surface part of the electronic apparatus 100 is toward.

The electronic apparatus 100 may change the sensing direction of the LiDAR sensor 110 in an up to down direction. Here, the vertical direction may vary according to a tilting angle of the LiDAR sensor 110. Here, as described above, the electronic apparatus 100 may control the driving part of the LiDAR sensor 110 to sense the surroundings of the electronic apparatus 100 omnidirectionally in 360 degrees.

Here, the electronic apparatus 100 may include an actuator for controlling the sensing direction of the LiDAR sensor 110. The actuator may be implemented as a motor. The electronic apparatus 100 may control the LiDAR sensor 110 to change the sensing direction. Here, the actuator may include an encoder. Here, the encoder may record a tilting angle according to a sensing direction.

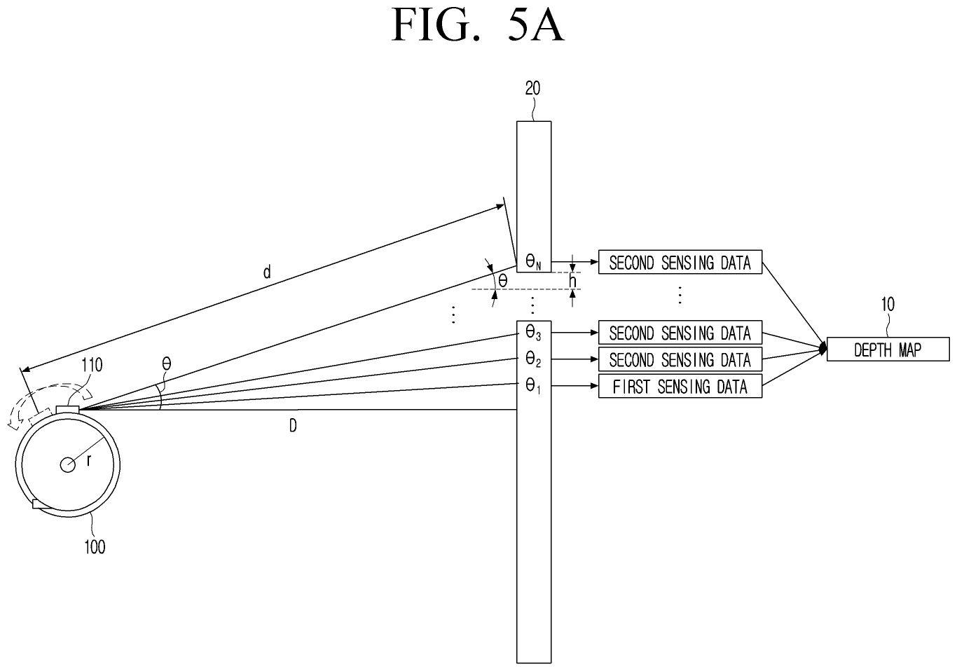

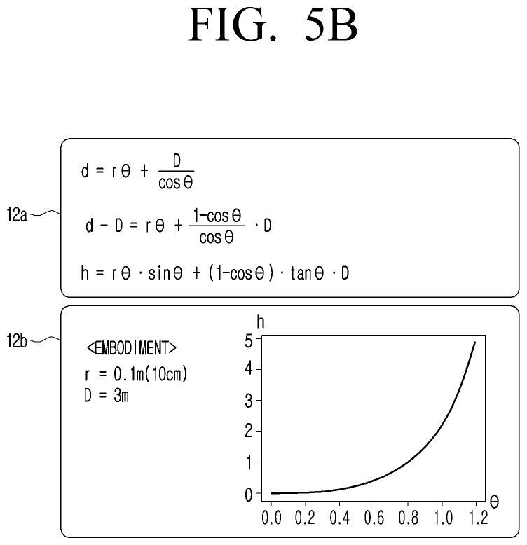

Here, sequentially changing the sensing direction may mean that the electronic apparatus 100 changes the sensing direction of the LiDAR sensor 110 to one direction several times. Unlike this, the electronic apparatus 100 may consecutively change the sensing direction of the LiDAR sensor 110. Detailed explanation in this regard will be described in FIG. 5B.

As an example, after the electronic apparatus 100 obtains the first sensing data, the electronic apparatus 100 may change the sensing angle of the LiDAR sensor 110 in up or down directions in a vertical direction several times.

As an example, after the electronic apparatus 100 changes the sensing direction of the LiDAR sensor 110 according to a final angle by changing the sensing direction several times, the electronic apparatus 100 may sequentially change the sensing direction from the final angle again.

Here, the electronic apparatus 100 may change the sensing direction sequentially according to a predetermined angle interval. As an example, the predetermined angle interval may be a regular angle interval. However, the disclosure is not limited thereto, and the predetermined angle interval may be an irregular interval as the sensing direction of the LiDAR sensor 110 is sequentially changed.

Meanwhile, in a state where a range of a left to right sensing direction of the LiDAR sensor 110 is within a predetermined angle range, the electronic apparatus 100 may control the sensing direction of the LiDAR sensor 110 to be changed sequentially in an up to down direction. Here, the left to right sensing direction may be referred to as a horizontal sensing direction.

Here, the range of the left to right sensing direction may be a range of a direction in which the LiDAR sensor 110 senses a space horizontally. That is, in case the LiDAR sensor 110 senses the space around the electronic apparatus 100 omnidirectionally, the electronic apparatus 100 may limit the sensing direction to a predetermined angle range. However, the disclosure is not limited thereto, and the predetermined angle range may correspond to various angle ranges set by the driving direction of the electronic apparatus 100, the location of the electronic apparatus 100, and the user setting.

Accordingly, in case the electronic apparatus 100 does not need distance information for spaces excluding the aforementioned space wherein the angle range is limited among the spaces around the electronic apparatus 100, the electronic apparatus 100 may limit the sensing range to an angle range depending on needs, and thus an unnecessary data processing process can be omitted, and power consumption can be reduced.

The electronic apparatus 100 may change the sensing direction of the LiDAR sensor 110 sequentially, and obtain the second sensing data in each sensing direction. Then, the electronic apparatus 100 may store the obtained second sensing data in the memory 120, and accumulatively store the plurality of second sensing data according to each sensing direction in the memory 120.

FIG. 5A and FIG. 5B are diagrams for illustrating an operation of obtaining a depth map according to at least one embodiment of the disclosure.

According to FIG. 5A, the electronic apparatus 100 is spaced from a wall surface which is a space 20 by a distance D, and the LiDAR sensor 110 may sense the space 20 in sensing directions corresponding to a plurality of angles θ₁, θ₂, θ₃, . . . , θₙ, It will be assumed that the electronic apparatus 100 is spaced from a space corresponding to a direction according to the final angle θₙ by the distance D.

The electronic apparatus 100 may sense the space 20 with a sensing direction of the LiDAR sensor 110 corresponding to the predetermined angle 1, and obtain the first sensing data through the LiDAR sensor 110. Then, the electronic apparatus 100 may control the sensing direction of the LiDAR sensor 110 to be changed sequentially (θ₁, θ₂, θ₃ . . . , θₙ), and obtain the plurality of second sensing data.

Meanwhile, as described above, while the range of the left to right sensing direction of the LiDAR sensor 110 is within the predetermined angle range, the electronic apparatus 100 may obtain the second sensing data while changing the sensing direction of the LiDAR sensor 110 to an up to down direction.

Here, the electronic apparatus 100 may sense the space on the opposite side to the direction which the electronic apparatus 100 is toward (the rear surface part). That is, as the sensing direction of the LiDAR sensor 110 is changed as the electronic apparatus 100 or the LiDAR sensor 110 is tilted, the electronic apparatus 100 may sense the space on the opposite side.

Specifically, the electronic apparatus 100 controls the LiDAR sensor 110 to sense a space with a sensing direction corresponding to a predetermined angle according to a predetermined event. Here, the electronic apparatus 100 may control the LiDAR sensor 110 to sense the space on the opposite side, and obtain the first sensing data for the space on the opposite side.

Afterwards, the electronic apparatus 100 senses the space by controlling the sensing direction of the LiDAR sensor 110. Here, the electronic apparatus 100 may control the LiDAR sensor 110 to sense even an object in a bottom area existing in the space on the opposite side, and obtain the plurality of second sensing data through the LiDAR sensor 110.

Accordingly, the LiDAR sensor 110 may sense an obstacle existing on the rear side of the electronic apparatus 100 or a charging station device for charging the electronic apparatus 100, and thus the electronic apparatus 100 may obtain distance information from the electronic apparatus 100 to the obstacle or the charging station.

Meanwhile, according to FIG. 5A and FIG. 5B, D indicates a distance between the electronic apparatus 100 and the LiDAR sensor 110. ( ) indicates a rotation angle (rad) of the actuator (a tilting motor). r refers to a radius of the electronic apparatus 100. d refers to a distance between the tilted LiDAR sensor 110 and the wall surface.

h may mean an offset of sensing points between the upper and lower sides in case the LiDAR sensor 110 is tilted after sensing a limited left to right angle range, and rotates in 360 degrees again, and then senses the limited angle range. For example, as the LiDAR sensor 110 senses a limited angle range in a row in a left to right direction while rotating, sensing points are arranged in a row and form the first row. Afterwards, in case the LiDAR sensor 110 senses the space by being tilted upward and rotating in 360 degrees again, the sensing points are arranged in the second row over the first row. Here, h may mean an interval between the first row and the second row.

However, according to an embodiment, in case the LiDAR sensor 110 senses a limited left to right angle range while rotating, and the LiDAR sensor 110 is consecutively tilted upward at the same time, the aforementioned first row and second row, etc. may not be expressed to be parallel with the ground. For example, if the rotation direction of the LiDAR sensor 110 is from left to right when facing the space, the first row and the second row, etc. may express a form toward a right upper direction. In this case, the h value may also mean an interval between the first row and the second row.

According to the formula 12a in FIG. 5B, the distance d may correspond to a value of summing up a distance that the LiDAR sensor 110 moved while being tilted and a distance from a sensing point when the LiDAR sensor 110 was tilted by a tilting angle θ from the original location of the LiDAR sensor 110. Referring to the drawing in FIG. 5A, the distance d may be expressed as the following formula 1 and formula 2 by using the distance D, the radius r, and the angle θ.

$$d = r θ + \frac{D}{cos θ} \qquad [ Formula 1 ]$$

$$d - D = r θ + \frac{1 - cos θ}{cos θ} \cdot D \qquad [ Formula 2 ]$$

Meanwhile, the interval h between the upper and lower sides may be expressed as the following formula 3 from the distance d, D and the angle.

$$h = ( d - D ) sin θ \qquad [ Formula 3 ]$$

Based on the formulae 1 to 3, the interval h between the upper and lower sides may be expressed as a function for “according to the following formula 4.

$$h = r θ \cdot sin θ + ( 1 - cos θ ) \cdot tan θ \cdot D \qquad [ Formula 4 ]$$

That is, as the tilting angle θ increases, the h value increases. The graph 12b indicates the h value according to the change of the θ value in case r=0.1 m (10 cm), D=3 m. As the θ value increases, the tilt also increases, and the h value increases.

That is, in case the LiDAR sensor 110 senses a space while gradually increasing the tilting angle, the interval h between the upper and lower sides of the sensing point increases, and accordingly, the density of the sensing point may decrease. Accordingly, in case a depth map was formed based on the sensing data obtained by the LiDAR sensor 110, a form wherein an interval of distance values becomes wider as it becomes farther from a sensing point close to the LiDAR sensor 110 may be indicated.

Returning to FIG. 5A, the electronic apparatus 100 may obtain the first sensing data and the plurality of second sensing data according to the aforementioned various methods. Afterwards, the electronic apparatus 100 may obtain the depth map 10 including distance information of the space 20 based on the first sensing data and the plurality of second sensing data.

Specifically, as described above, each of the first sensing data and the plurality of second sensing data may include a difference between a phase of a received reflective light and a phase of an output light. The electronic apparatus 100 may identify a plurality of distance values for the spaces in the directions wherein each sensing data was obtained based on the phase differences included in each sensing data.

The electronic apparatus 100 may obtain the depth map 10 including distance information of the space 20. The distance information may include a plurality of coordinates and distance values corresponding to each coordinate.

Here, each of the plurality of coordinates is a coordinate in a virtual 3D space, and may correspond to a point wherein the LiDAR sensor 110 sensed the space 20. Here, the sensing point may mean a point wherein a light output by the LiDAR sensor 110 was reflected in the space 20.

The electronic apparatus 100 may obtain a rotation angle from the encoder of the LiDAR sensor 110 described above, and obtain a tilting angle from the encoder of the actuator described above. The electronic apparatus 100 may match the obtained rotation angle and tilting angle, and identify a sensing point.

The electronic apparatus 100 may identify a plurality of coordinates through the sensing point and the identified distance value. That is, the electronic apparatus 100 may map the sensing point and the distance value of the point to a virtual 3D space, and identify a plurality of coordinates in the 3D space. Here, information on the sensing point may be obtained by an encoder of the motor for controlling rotation of the LiDAR sensor 110. The encoder may mean a device that measures a rotation angle or the speed of the motor. The LiDAR sensor 110 may obtain information on the sensing point by identifying the rotation angle at the time when the encoder recorded it on the time point of outputting a light.

Meanwhile, the electronic apparatus 100 may input the first sensing data and the plurality of second sensing data into an artificial intelligence model, and obtain a depth map.

Here, the artificial intelligence model may be a model that was trained to obtain a depth information including distance information between an object included in a space and the LiDAR sensor 110 based on first training sensing data received from the LiDAR sensor 110 and a plurality of second training sensing data received by controlling the LiDAR sensor 110 to change the sensing direction sequentially.

Compared to a case of sensing a space while the LiDAR sensor 110 of the electronic apparatus 100 is fixed toward the center of the space, in case the electronic apparatus 100 obtains distance information based on the first sensing data and the plurality of second sensing data according to a predetermined event as described above, a depth map including more affluent distance information can be obtained.

Meanwhile, the electronic apparatus 100 may obtain other information in addition to the distance information of the space 20 based on the first sensing data and the plurality of second sensing data. The electronic apparatus 100 may update the distance information included in the depth map 10 that was obtained earlier based on the obtained other information.

For example, the electronic apparatus 100 may obtain information on the structure of the space based on the first sensing data and the plurality of second sensing data.

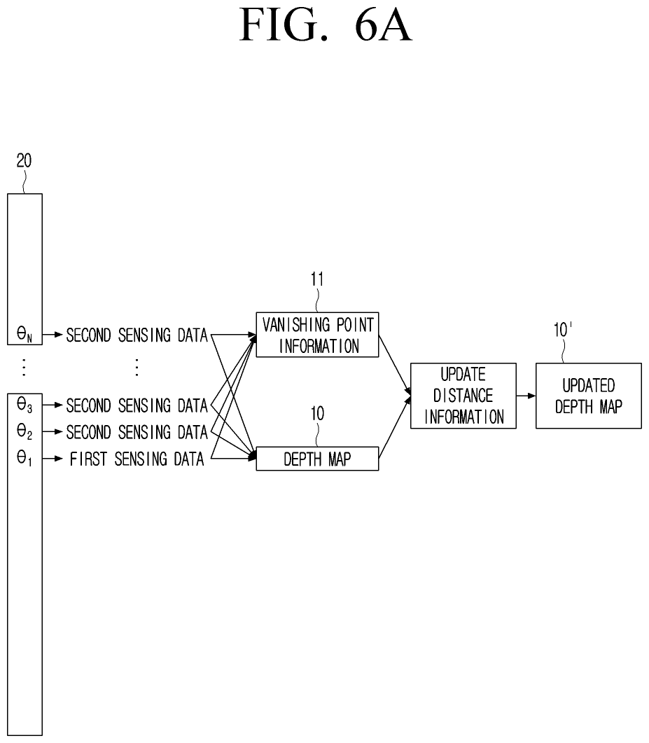

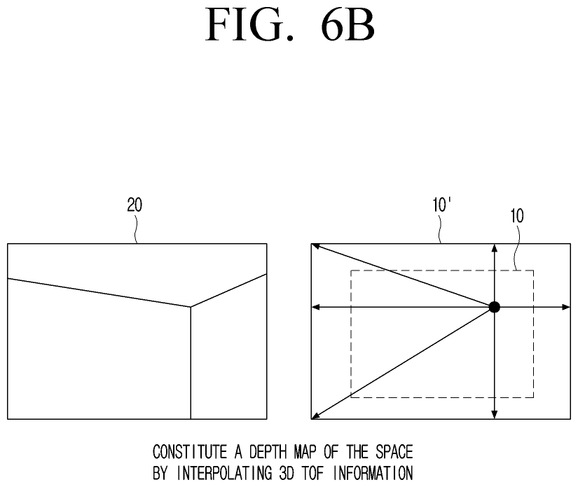

FIG. 6A and FIG. 6B are diagrams for illustrating an operation of obtaining information on a vanishing point according to at least one embodiment of the disclosure.

According to FIG. 6, the electronic apparatus 100 may obtain information on a vanishing point 11 based on the first sensing data and the plurality of second sensing data.

Specifically, the electronic apparatus 100 may detect a vanishing point. Here, the vanishing point may mean a point wherein it looks as if different parallel straight lines detected from the space converge.

Specifically, the electronic apparatus 100 may obtain the distance information of the space 20 based on the first sensing data and the plurality of second sensing data.

The electronic apparatus 100 may identify an edge based on the obtained distance information. Here, the edge may be detected by an edge detection algorithm (e.g.: a Canny edge detection algorithm). Specifically, the electronic apparatus 100 may identify two coordinates for which a change of a distance value is the maximum, and obtain edge coordinates of a point located in the center between the two coordinates. The electronic apparatus 100 may identify one edge including the plurality of obtained edge coordinates. The electronic apparatus 100 may repeat such a process for the distance information, and identify a plurality of edges through the LiDAR sensor 110.

The electronic apparatus 100 may identify a plurality of straight lines among the plurality of identified edges. Here, the straight lines may be detected by a straight line detection algorithm (e.g.: a Hough Transform algorithm). Specifically, the electronic apparatus 100 may detect straight lines on an intersecting point in a new coordinate space expressed by performing Hough transform for the edge coordinates. Here, Hough transform means transforming a straight line equation into a parameter (e.g.: a tilt and an intercept) space. Straight lines may be detected on a point wherein the plurality of obtained straight lines intersect in the parameter space. Here, straight lines may be detected by substituting the coordinates of the intersecting point into a straight line equation. However, such an algorithm for detecting straight lines is merely an example, and a straight line detection algorithm may be implemented by various methods. Here, the detected straight lines may be expressed in a form of a 3D equation in a virtual 3D space.

The electronic apparatus 100 may identify one or more coordinates wherein the plurality of identified straight lines converge or intersect. The electronic apparatus 100 may identify the identified one or more coordinates as the coordinates of the vanishing point. Also, the electronic apparatus 100 may identify information on the plurality of straight lines that converge or intersect on the identified vanishing point as vanishing line information. Here, the vanishing line information may include the plurality of coordinates included in the vanishing line. Alternatively, the vanishing line information may be expressed as the aforementioned 3D equation.

The electronic apparatus 100 may obtain the obtained vanishing point coordinates and vanishing line information as the vanishing point information.

The electronic apparatus 100 may update the distance information based on the obtained vanishing point information. Hereinafter, detailed explanation in this regard will be described.

The electronic apparatus 100 may interpolate the distance information based on the coordinates of the vanishing point and the vanishing line information. Here, interpolation may mean a technic of assuming unknown data by obtaining an interpolating polynomial from the previously known data.

Here, the previously known data may be distance information that the electronic apparatus 100 obtained based on the first sensing data and the second sensing data. The unknown data will be explained below.

As described above, the LiDAR sensor 110 outputs a light while rotating, and does not output a light during a predetermined time interval, and outputs a light again after the predetermined time passes. While the LiDAR sensor 110 does not output a light, the LiDAR sensor 110 does not receive a light, and thus a phase difference cannot be identified. Accordingly, the electronic apparatus 100 cannot obtain a distance value only for coordinates of a specific interval. That is, a distance value may not exist for a specific area. The aforementioned unknown data may mean distance values corresponding to each of a plurality of coordinate values occupied by such a specific area.

The electronic apparatus 100 may identify the coordinates of the vanishing point and the plurality of coordinate values included in the vanishing line information as updated coordinates of a predetermined interval. The predetermined interval may mean an interval between the updated coordinates, and may be a value that can be set according to a targeted resolution. The electronic apparatus 100 may obtain updated distance values from each of the plurality of identified updated coordinates. Specifically, the electronic apparatus 100 may obtain updated distance values from the updated coordinates through an inverse process of the aforementioned process of mapping a sensing point and a distance value to a 3D space. Accordingly, the electronic apparatus 100 may obtain updated distance information including the updated coordinates and the updated distance values.

Meanwhile, the electronic apparatus 100 may extend the vanishing line based on the coordinates of the vanishing point, and identify the plurality of coordinates included in the extended vanishing line as the updated coordinates. The electronic apparatus 100 may obtain the updated distance values from each of the plurality of identified updated coordinates. Accordingly, the electronic apparatus 100 may obtain the updated distance information including the updated coordinates and the updated distance values. That is, the electronic apparatus 100 may linearly extend the distance information obtained based on the first sensing data and the second sensing data.

According to FIG. 6B, the electronic apparatus 100 may obtain a new depth map 10′ including the updated distance information.

That is, the electronic apparatus 100 may interpolate distance information (or 3D ToF information) previously obtained based on the first sensing data and the second sensing data on the basis of the vanishing point information, and obtain a space depth map including more distance information.

Accordingly, the electronic apparatus 100 may obtain a first depth map 10 based on the first sensing data and the second sensing data, and obtain a second depth map (or a new depth map) 10′ by updating the first depth map based on the vanishing point information.

Meanwhile, the electronic apparatus 100 may update the distance information of the depth map 10 based on the third sensing data obtained by the RGB sensor 140 other than the LiDAR sensor 110.

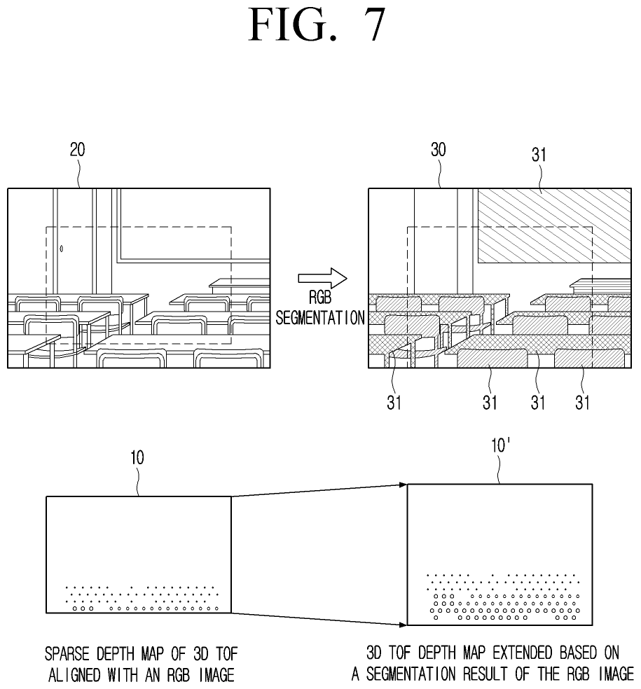

FIG. 7 to FIG. 10 are diagrams for illustrating an operation of updating distance information according to at least one embodiment of the disclosure.

According to FIG. 7, the electronic apparatus 100 may obtain an extended depth map 10′ from a sparse depth map. Here, the extended depth map 10′ may also be referred to as an updated depth map or a dense depth map.

Here, in case an average of distance values between two adjacent coordinates among the plurality of coordinate values included in the distance information is greater than or equal to a threshold value, a depth map including such distance information may be referred to as the sparse depth map 10. In contrast, in case an average of distance values between two adjacent coordinates is smaller than or equal to the threshold value, a depth map including such distance information may be referred to as the dense depth map 10.

The extended depth map 10′ may include distance information wherein the distance information included in the sparse depth map 10 was updated. Accordingly, the extended depth map 10′ may include distance information for the space 20 of a wider field of view (FoV) than the sparse depth map 10.

The electronic apparatus 100 may utilize a color image of the space 20 for obtaining the extended depth map 10′.

The space 20 may include a plurality of objects (e.g.: a plurality of chairs, a plurality of desks, a blackboard, etc.). The electronic apparatus 100 may obtain a segmentation image 30 by performing RGB segmentation for a color image that captured the plurality of objects.

Here, the segmentation image 30 may include a plurality of object areas 31 divided in different colors according to the types of each object (e.g.: the chairs, the desks, the blackboard). The plurality of object areas 31 may also be displayed while being divided in different patterns (e.g., slashes, checks, lateral stripes, etc.) for each object.

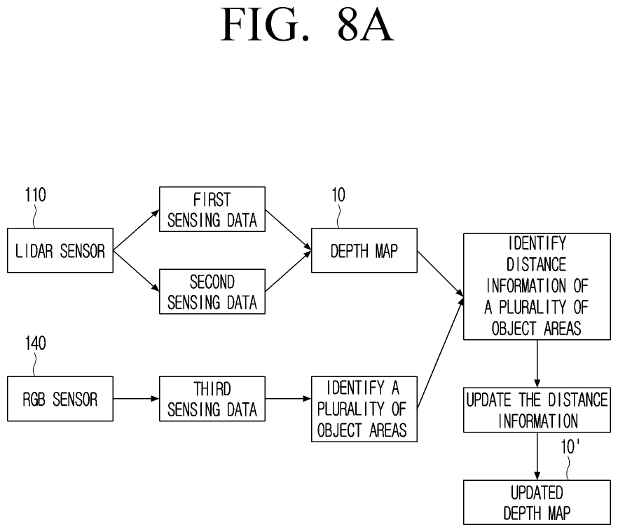

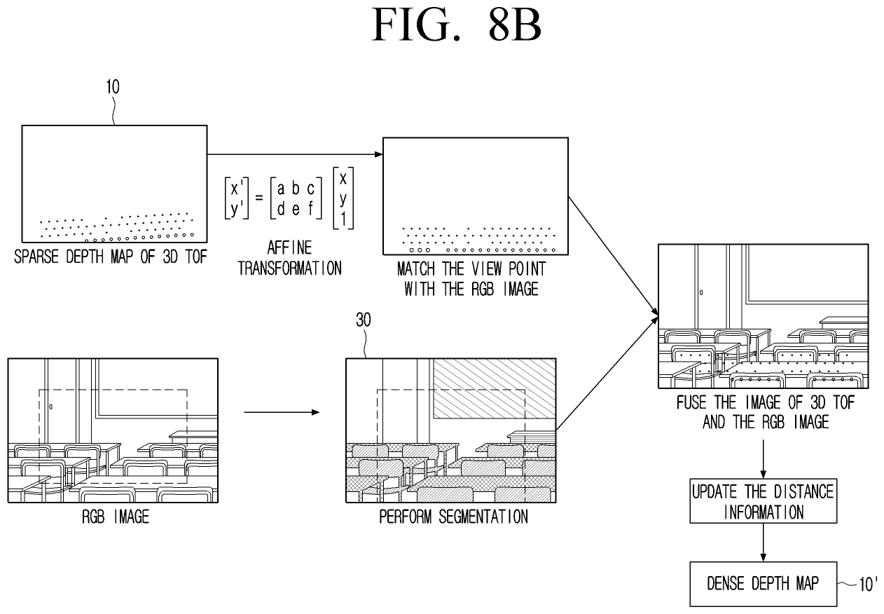

The electronic apparatus 100 may obtain the extended depth map 10′ based on the distance information of the space 20 included in the depth 10 and the plurality of object areas 31. Hereinafter, detailed explanation in this regard will be described through FIG. 8.

According to FIG. 8, the electronic apparatus 100 may obtain the depth map 10 based on the first sensing data and the second sensing data obtained by the LiDAR sensor 110.

The electronic apparatus 100 may identify the plurality of object areas 31 based on the third sensing data obtained through the RGB sensor 140.

The electronic apparatus 100 may obtain a color image of the space 20 as the third sensing data.

The electronic apparatus 100 may segment the RGB image, and identify the plurality of object areas 31.

Specifically, the electronic apparatus 100 may obtain a segmentation image 30 including segmentation information for the areas 31 corresponding to each of a plurality of objects (referred to as the object areas hereinafter) included in the color image. That is, the electronic apparatus 100 may identify a plurality of objects included in the color image for the space 20 by using a segmentation model, and obtain the segmentation image 30 indicating the segmentation information for the plurality of object areas 31 in colors (or patterns) corresponding thereto. Here, the plurality of object areas 31 may correspond to areas occupied by specific objects in the segmentation image 30.

The electronic apparatus 100 may identify distance information of the plurality of object areas identified in the third sensing data based on the distance information included in the depth map 10 described above.

Specifically, the electronic apparatus 100 may align a depth map with an image obtained through the RGB sensor, and identify distance information of each of the at least one object. The electronic apparatus 100 may identify at least one point that is overlapped with the object areas 31 included in the segmentation image 30, and identify distance values of the objects. Here, the points may be points which are included in the depth map 10, and of which sizes are different according to the distance values corresponding to each coordinate.

As an example, the electronic apparatus 100 may identify a point of the smallest size among the at least one point, and identify the distance value corresponding to the size as the distance of the object areas. That is, the electronic apparatus 100 may identify a point in the farthest location among the points overlapped with the objects, and identify the distance corresponding to the point as the distance of the object areas.

As an example, the electronic apparatus 100 may identify a point of the biggest size among the points overlapped with the object areas 31, and identify the point in the closest location as the distance of the objects. Alternatively, the electronic apparatus 100 may identify a plurality of overlapped points, and identify an average of the distance values corresponding to the sizes of each point as the distance value of the objects.

The electronic apparatus 100 may identify distance information of the object areas. The distance information of the object areas may include the identified distance value.

Meanwhile, the LiDAR sensor 110 and the RGB sensor 140 may be mounted in different locations of the electronic apparatus 100, and sense a space. The LiDAR sensor 110 and the RGB sensor 140 may sense a space in different angles. In case there are differences in the locations and the angles of each of the LiDAR sensor 110 and the RGB sensor 140 as above, an error may be generated in the distance information of the plurality of object areas.

According to FIG. 8B, for compensating such a difference, the electronic apparatus 100 may match a view point of the sensing data.

Specifically, the electronic apparatus 100 may match the view points of the first sensing data and the second sensing data obtained through the LiDAR sensor 110, and the third sensing data obtained through the RGB sensor.

As an example, here, the feature that the electronic apparatus 100 matches the view points of the first sensing data, the second sensing data, and the third sensing data may mean coinciding the view points by performing coordinate transformation of a depth map obtained through the first sensing data and the second sensing data.

First, the electronic apparatus 100 may identify a difference in sensing angles. Specifically, the electronic apparatus 100 may perform calibration for identifying relative locations and angles of the RGB sensor and the LiDAR sensor 110. For example, the electronic apparatus 100 may identify sensing angles of each sensor by using a calibration pattern (e.g.: a checkerboard, etc.), and identify a difference in the sensing angles. Here, the calibration pattern may be a pattern drawn indoors or outdoors, or an image output by an external electronic apparatus, or an image projected by the electronic apparatus 100 on an indoor or an outdoor wall surface through a projection device.

The electronic apparatus 100 may perform coordinate transformation for each of the plurality of coordinates for compensating a sensing angle difference as above. Here, coordinate transformation may be based on a difference of sensing angles of each of the LiDAR sensor 110 and the RGB sensor 140. For example, coordinate transformation may be Affine transformation. Affine transformation maintains the characteristics of linear transformation, and maintains parallelism after transformation. That is, the electronic apparatus 100 may maintain distance values corresponding to each coordinate with respect to each of the plurality of coordinate values, and transform each coordinate into a new coordinate.

The electronic apparatus 100 may obtain new transformation distance information through the aforementioned coordinate transformation. The transformation distance information may include a plurality of transformed coordinates and distance values corresponding to each coordinate. The electronic apparatus 100 may obtain a transformation depth map including the transformation distance information. The transformation depth map 10 may be a depth map wherein the view point was matched with an RGB image.

For example, the transformation depth map 10 may be implemented as a 2D image as the plurality of transformed coordinates are respectively mapped to corresponding locations. The locations of each point may correspond to the transformed coordinates.

The electronic apparatus 100 may align (or fuse) the transformed depth map with an image obtained through the RGB sensor, and identify distance information of each of at least one object area. The electronic apparatus 100 may identify at least one point overlapped with the object areas 31 existing in the segmentation image, and identify distance information of the object areas. As an operation of the electronic apparatus 100 of identifying the distance information of the object areas was explained in detail in the aforementioned part, overlapping explanation will be omitted.

Afterwards, the electronic apparatus 100 may update the distance information included in the depth map 10 based on the identified distance information of the object areas, and the depth map may be referred to as an updated depth map (or a dense depth map) 10′ including the updated distance information. A detailed content in this regard will be explained returning to FIG. 8A.

Returning to FIG. 8A, the electronic apparatus 100 may identify distance information of the plurality of object areas identified in the third sensing data based on the distance information included in the depth map 10, and update the distance information included in the depth map 10 based on the identified distance information of the plurality of object areas.

As an example, the electronic apparatus 100 may identify areas corresponding to each of the plurality of object areas 31 in the depth map 10 based on the plurality of object areas 31 included in the third sensing data, and update the areas corresponding to each of the plurality of object areas 31 in the depth map 10 with the same distance information.

Here, the corresponding areas may mean areas overlapped with the object areas 31 in the depth map 10, in case the depth map or the transformation depth map is aligned with the segmentation image 30.

The electronic apparatus 100 may update the distance information by mapping the distance values to the coordinates occupied by the corresponding areas in the depth map 10.

Here, the same distance information may be one of a minimum distance value, a maximum distance value, or an average distance value in the object areas according to the aforementioned embodiment.

Suggesting FIG. 7 as an example, the electronic apparatus 100 may update an area corresponding to an area of the closest desk in the depth map 10 with the same distance information.

According to the aforementioned example, in case the electronic apparatus 100 matched the view points of the first sensing data to the third sensing data, the electronic apparatus 100 may update the distance information included in the depth map based on the first sensing data, the second sensing data, and the third sensing data with view points matched. That is, the electronic apparatus 100 may update the distance information included in the depth map by aligning the transformation depth map obtained by transforming the depth map with the segmentation image 30.

The electronic apparatus 100 may obtain an updated depth map 10′ based on the updated distance information.

Meanwhile, the electronic apparatus 100 may identify the structure information of the space 20 by using the aforementioned segmentation image 30.

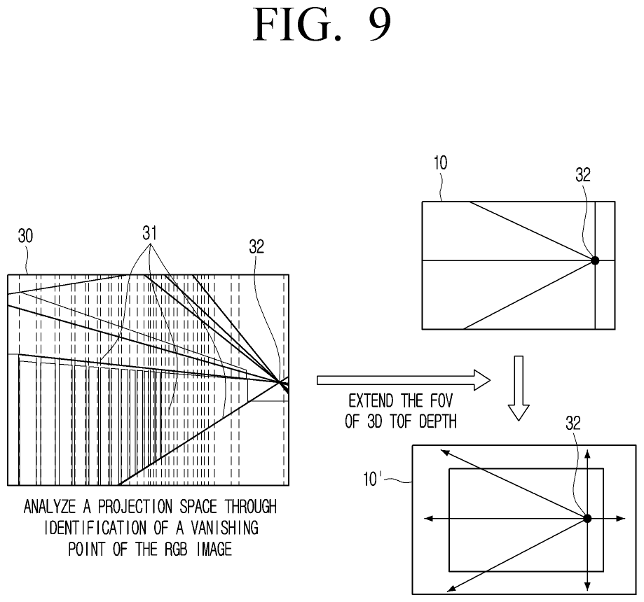

According to FIG. 9, the electronic apparatus 100 obtains a segmentation image 30 for the space 20, and obtains information on a vanishing point 32 of the space 20 through this.

Here, the vanishing point 32 may correspond to a point where it looks as if the plurality of parallel lines included in the segmentation image 30 converge.

The electronic apparatus 100 may analyze a projection space through identification of the vanishing point 32, and extend the distance information with the image vanishing point 32 as the center. The electronic apparatus 100 may update the distance information included in the depth map 10 based on the information on the vanishing point 32, and obtain the updated depth map 10′.

Here, the updated depth map 10′ may include distance information wherein the distance information included in the sparse depth map 10 was updated. Accordingly, the extended depth map 10′ may include distance information for the space 20 of a wider field of view (FoV) than the sparse depth map 10.

An operation of the electronic apparatus 100 of updating the distance information based on the information on the vanishing point 32 will be described in detail below.

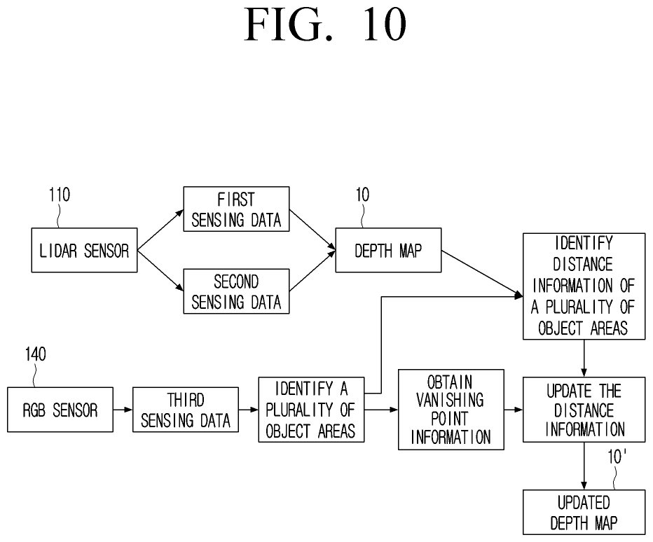

According to FIG. 10, the electronic apparatus 100 may identify a plurality of object areas 31 included in the third sensing data obtained through the RGB sensor. The electronic apparatus 100 may identify at least one vanishing point 32 based on the plurality of identified object areas 31.

The electronic apparatus 100 may identify an edge based on the plurality of identified object areas 31. Here, the edge may be detected by an edge detection algorithm (e.g.: a Canny edge detection algorithm). Specifically, the electronic apparatus 100 may identify a boundary of two objects wherein the change of the R, G, B values is the maximum as an edge. The electronic apparatus 100 may identify a plurality of edges for an RGB segmentation image 30 by repeating the process as above.

The electronic apparatus 100 may identify a plurality of straight lines among the plurality of identified edges. Here, the straight lines may be detected by a straight line detection algorithm (e.g.: a Hough Transform algorithm). As a detailed content regarding a straight line detection algorithm was explained in FIG. 6A, overlapping explanation will be omitted.

The electronic apparatus 100 may identify at least one vanishing point 32 on which the plurality of identified straight lines converge. Specifically, the electronic apparatus 100 may identify a vanishing point through at least one vanishing point detection algorithm. Such an algorithm may be stored in the memory 120.

Here, the vanishing point detection algorithm may correspond to an algorithm that extracts a plurality of vanishing point candidates, and repeats the same step until the locations of the vanishing point candidates converge, or repeats different steps and can thereby detect one vanishing point 32.

As an example, the electronic apparatus 100 may obtain a vanishing point through a J-Linkage (JL) clustering algorithm. The JL clustering algorithm may correspond to an algorithm that clusters a plurality of identified straight lines into a plurality of models and generates a plurality of vanishing point candidates, and detects a vanishing point based on similarity among the straight lines.

As an example, the electronic apparatus 100 may obtain a vanishing point through an expectation-maximization (EM) algorithm. The EM algorithm may correspond to an iterative algorithm that finds an assumption value of a parameter having a maximum likelihood or a maximum a posteriori (MAP) in a probability model dependent on a latent variable. That is, the EM algorithm may correspond to an algorithm that obtains a plurality of random vanishing point candidates, and calculates a probability that a plurality of straight lines would belong to each vanishing point candidate (E-step), and updates the vanishing point candidates to locations with a higher possibility according to the calculated probability (M-step), and repeats the E-step and the M-step until the vanishing point candidates converge on one point, and thereby detects a vanishing point.

However, the aforementioned algorithm is merely an example of an algorithm for detection of a vanishing point, and the electronic apparatus 100 may obtain a vanishing point through vanishing point detection algorithms by various methods other than this. Also, the electronic apparatus 100 may detect the vanishing point 32 through a single algorithm, or obtain the vanishing point 32 by combining different algorithms.

Afterwards, the electronic apparatus 100 may identify, from the segmentation image 30, the location of the vanishing point 32 and locations of a plurality of vanishing lines that converge on the vanishing point 32 in the depth map 10. Specifically, the electronic apparatus 100 may align the depth map 10 with the segmentation image 30, and identify the location of the vanishing point 32 and the locations of the plurality of vanishing lines.

The electronic apparatus 100 may obtain the location of the vanishing point 32 and the locations of the plurality of vanishing lines that converge on the vanishing point 32 as vanishing point information.

The electronic apparatus 100 may update the distance information included in the depth map 10 based on the obtained vanishing point information 32. That is, the electronic apparatus 100 may interpolate the distance information based on the vanishing point information. Detailed explanation in this regard will be described below.

The electronic apparatus 100 may identify an area between neighboring vanishing lines among the plurality of vanishing lines as a plain (e.g.: a bottom, a wall, or a ceiling) area that gets farther toward the vanishing point 32. Here, the plain area may be an area on the depth map 10.

The electronic apparatus 100 may identify the distance value of the vanishing point 32. Specifically, the electronic apparatus 100 may identify the distance value of the closest point to the location of the vanishing point 32 as the distance value of the vanishing point 32. However, the disclosure is not limited thereto.

The electronic apparatus 100 may obtain a distance value by a predetermined interval based on the vanishing point 32 with respect to the plain area. Specifically, the electronic apparatus 100 may obtain a distance value that decreases from the distance value of the vanishing point 32 as it gets farther based on the vanishing point 32. Here, the degree that the distance value decreases (e.g.: a change amount of the distance value per unit length) may increase as it gets farther from the location of the vanishing point 32. Here, the obtained distance value may be referred to as an updated distance value, and a coordinate corresponding to the point wherein the distance value was obtained on the depth map 10 may be referred to as an updated coordinate.

Accordingly, the electronic apparatus 100 may obtain updated distance information including the updated coordinate value and the updated distance value. The electronic apparatus 100 may obtain a new depth map 10′ including the updated distance information.

Meanwhile, returning to FIG. 9, in case a field of view that can be sensed by the LiDAR sensor 110 is narrower than a field of view that can be sensed by the RGB sensor 140, the electronic apparatus 100 may obtain a new depth map 10′ with an extended size.

That is, the electronic apparatus 100 may update the distance information included in the depth map 10 based on an RGB image that was obtained by the RGB sensor 140 by sensing a wider range than the field of view of the LiDAR sensor 110. The obtained updated distance information may include coordinates of a wider range than the previous distance information. Accordingly, the new depth map 10′ obtained by the electronic apparatus 100 by the updated distance information may include distance information of a wider area than the previous depth map 10.

Accordingly, the electronic apparatus 100 may obtain distance information in a field of view (FoV) greater than or equal to the FoV of the LiDAR sensor 110. That is, the electronic apparatus 100 may obtain updated distance information of a space in a wider range than an FoV according to the inherent characteristic of the LiDAR sensor 110 by updating the distance information.

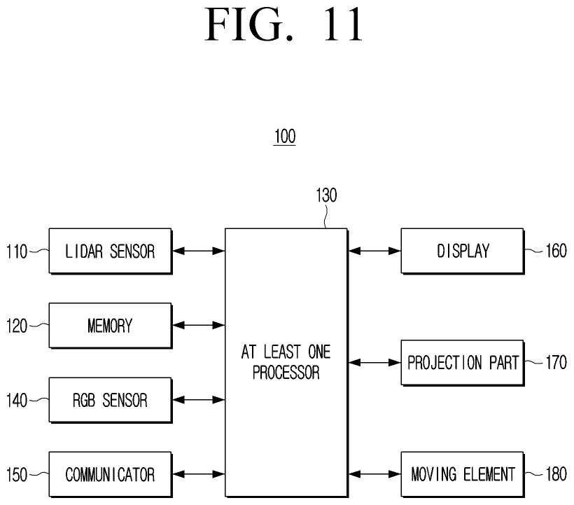

FIG. 11 is a detailed block diagram for illustrating a detailed configuration of an electronic apparatus according to at least one embodiment of the disclosure.

According to FIG. 11, the electronic apparatus 100 may include at least one of a LiDAR sensor 110, memory 120, an electronic apparatus 100, an RGB sensor 140, a communicator 150, a display 160, a projection part 170, or a moving element 180.

However, the components illustrated in FIG. 11 are merely one of various examples, and some components can be omitted, or new components can be added. Meanwhile, contents already explained in FIG. 2 will be omitted.

The communicator 150 is a component for the electronic apparatus 100 to perform communication with a plurality of external apparatuses. The communicator 150 may perform communication with at least one external electronic apparatus 200 or at least one server device.

The electronic apparatus 100 may receive a signal requesting a depth map of a space of an external apparatus from the external apparatus or a server device through the communicator 150, or receive a signal requesting the depth map 10 of the space 20 of the electronic apparatus 100 from the server device. Alternatively, the electronic apparatus 100 may transmit a signal requesting the depth map 10 of the space 20 to the external apparatus or the server device through the communicator 150.

The communicator 160 may transmit and receive various types of signals and data with external apparatuses through various types of wired or wireless communication methods such as Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc. other than Bluetooth and AP-based Wi-Fi (Wi-Fi, a wireless LAN network).

Meanwhile, the communicator 150 may include a plurality of communi cation modules for performing different functions. According to an embodiment of the disclosure, the electronic apparatus 100 may separately include a communication module for communicating with an external electronic apparatus 200 and a communication module for communicating with a server 300. For example, the electronic apparatus 100 may perform communication with the external electronic apparatus 200 by using a BT module, and perform communication with the server 300 by using a Wi-Fi module. However, the disclosure is not limited thereto.

The electronic apparatus 100 may further include an interface such as an HDMI port, a DP, an RGB, a DVI, a USB, a Thunderbolt, etc. for being connected with external content sources and receiving video/audio signals. An HDMI port, a DP, and a Thunderbolt are ports that can simultaneously transmit video and audio signals. The processor 820 performs various types of processing such as demuxing, decoding, scaling, etc. for a content received from a content source through the communicator 150 and such various interfaces and constitutes screen data, and provides the constituted screen data to the display.

Meanwhile, the electronic apparatus 100 may obtain distance information for a space based on additional information received from the external apparatus through the aforementioned communicator.

The electronic apparatus 100 may receive map information in a home from the external apparatus, and obtain a depth map based on the received information.

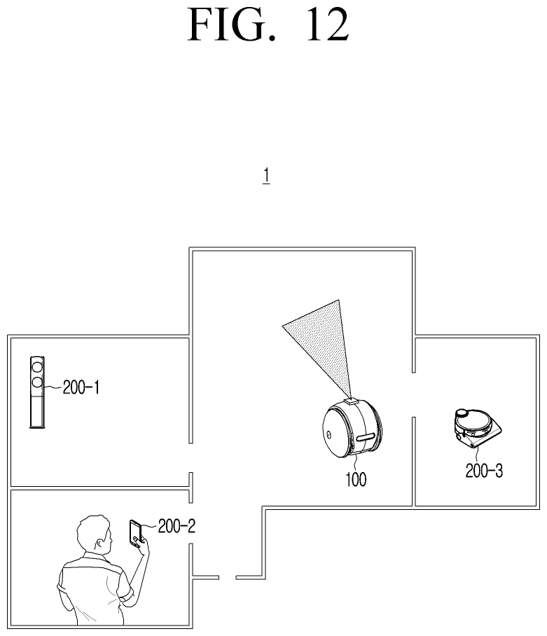

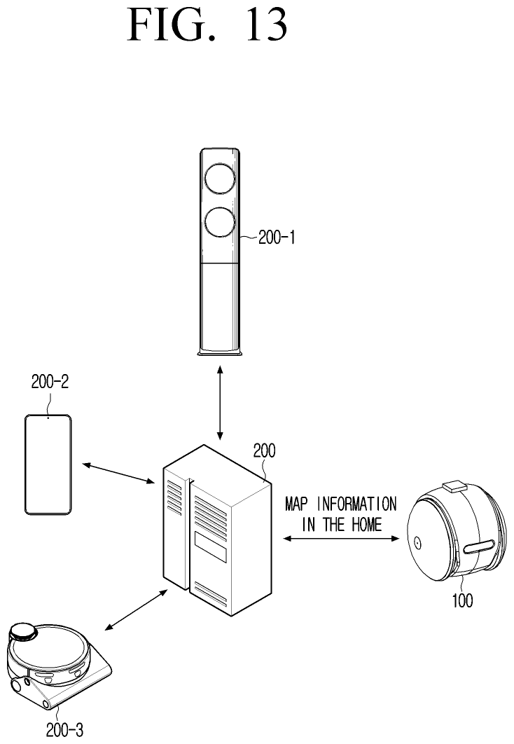

FIG. 12 and FIG. 13 are diagrams for illustrating map information in a home according to at least one embodiment of the disclosure.

Referring to FIG. 12, a wall or other objects for the electronic apparatus 100 to project a content in a range that can be sensed by the electronic apparatus 100 may not exist. Here, the range that can be sensed may mean a range that the LiDAR sensor 110 included in the electronic apparatus 100 can recognize the ambient environment. Here, the range that the LiDAR sensor 110 can recognize the ambient environment may include a distance range and an angle range (or an FoV range), etc.

In case a wall or other objects do not exist in a range that can be sensed by the electronic apparatus 100, the at least one processor 130 cannot obtain the first sensing data and the second sensing data, and may identify that objects do not exist in the surroundings.

In a case as above, the electronic apparatus 100 may receive indoor map information from external electronic apparatuses, etc. located in the home 1.

Here, the external electronic apparatuses 200 may be an air conditioner 200-1, a mobile device 200-2, a movable indoor robot 200-3, and a server that can communicate with an indoor electronic apparatus. The external electronic apparatuses were illustrated as the air conditioner 200-1, the mobile device 200-2, and the movable indoor robot 200-3, but the external electronic apparatuses are not limited thereto.

The external electronic apparatuses may be apparatuses that perform a similar function to the electronic apparatus 100 such as a movable projector, etc. Also, the external electronic apparatuses may include, for example, at least one of a television, a digital video disk (DVD) player, a smartphone, a tablet PC, an audio, a refrigerator, a cleaner, an oven, a microwave oven, a washing machine, an air purifier, a set top box, a home automation control panel, a security control panel, a media box, a camcorder, or an electronic photo frame. However, the disclosure is not limited thereto.

Referring to FIG. 13, the electronic apparatus 100 may perform communication with the external electronic apparatuses 200 such as the air conditioner 200-1, the mobile device 200-2, the movable indoor robot 200-3, and the server 300 that can communicate with an indoor electronic apparatus, etc.

The server 300 may be implemented as a server device, a cloud server device, etc., but is not limited thereto, and may be implemented as various devices such as a PC, a laptop PC, etc. In the disclosure, it was illustrated and described that the server 300 is a single server device, but the server 300 may be implemented as a plurality of servers.

As an example, in case the external electronic apparatuses 200 such as the air conditioner 200-1, the mobile device 200-2, the movable indoor robot 200-3, etc. are Internet of Things devices wherein a communication function is mounted, the server 300 may correspond to a device that can be connected with the external electronic apparatuses 200 by using a wireless network. In this case, the server 300 may construct an Internet of Things system with the external electronic apparatuses 200 which are Internet of Things devices.

The electronic apparatus 100 may request information in the map to the server 300 through the communicator 150.

The external electronic apparatuses 200 may obtain the information in the map or receive the information from an external apparatus, and store it. In particular, the movable indoor robot 200-3 may accumulate distance information of the ambient space while moving in the home 1. The movable indoor robot 200-3 may obtain the map information in the home 1 based on the accumulated distance information and store it.

When the server 300 receives a request signal from the electronic apparatus 100, the server 300 may transmit a signal requesting the map information in the home 1 to each external electronic apparatus 200, and in case each external electronic apparatus 200 stores the map information in the home 1, it may transmit the map information in the home 1 or the distance information to the server 300.

The electronic apparatus 100 may receive the map information or the distance information that the server 300 received from the external electronic apparatuses 200.

Accordingly, the electronic apparatus 100 may obtain a new depth map for a space outside the range that can be sensed based on the previously obtained distance information, the received map information in the home, and the new distance information.

Hereinafter, returning to the explanation in FIG. 11, the detailed configuration of the electronic apparatus 100 will be explained.

Referring to FIG. 11, the electronic apparatus 100 may include a display 160.

The display 160 is a component for displaying an operation state of the electronic apparatus 100 or a notification message, a UI screen, etc. The display 160 may be implemented as various forms of displays such as a liquid crystal display (LCD), an organic light emitting diodes (OLED) display, a plasma display panel (PDP), etc. Inside the display 160, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. Meanwhile, the display 160 may be implemented as a touch screen combined with a touch sensor, a flexible display, a three-dimensional (3D) display, etc. Alternatively, the display 160 may be implemented as only one or a plurality of light emitting diodes. The electronic apparatus 100 may change the display state of the display 160 according to various states such as when the electronic apparatus 100 is in a turned-on state, when the electronic apparatus 100 is normally operating, when the power is insufficient or the electronic apparatus 100 is in an error state, etc., and may thereby enable the user to intuitively identify the state of the electronic apparatus 100.

However, the components of the display 160 as above are merely some of various embodiments, and the components of the display 160 may be omitted. That is, the electronic apparatus 100 may be an apparatus that includes the display 160 in itself, or an apparatus that is connected with an external electronic apparatus. For example, in case the electronic apparatus 100 is implemented as a set top box, a one connect box, a projector, etc., the aforementioned operations of the electronic apparatus 100 may be performed in an electronic apparatus not including the display 160.

Meanwhile, the electronic apparatus 100 may include a projection part 170.

The projection part 170 is a component that projects an image to the outside. The projection part 170 according to the various embodiments of the disclosure may be implemented by various projection methods (e.g., a cathode-ray tube (CRT) method, a liquid crystal display (LCD) method, a digital light processing (DLP) method, a laser method, etc.). As an example, the CRT method has basically the same principle as a CRT monitor. In the CRT method, an image is enlarged to a lens in front of a cathode-ray tube (CRT), and the image is displayed on a screen. According to the number of cathode-ray tubes, the CRT method is divided into a one-tube method and a three-tube method, and in the case of the three-tube method, the method may be implemented while cathode-ray tubes of red, green, and blue colors are separated from one another.

As another example, the LCD method is a method of displaying an image by making a light output from a light source pass through a liquid crystal display. The LCD method is divided into a single-plate method and a three-plate method. In the case of the three-plate method, a light output from a light source may be divided into red, green, and blue colors in a dichroic mirror (a mirror that reflects only lights of specific colors, and makes the rest pass through), and pass through a liquid crystal display, and then the lights may be gathered in one place again.

As still another example, the DLP method is a method of displaying an image by using a digital micromirror device (DMD) chip. A projection part by the DLP method may include a light source, a color wheel, a DMD chip, a projection lens, etc. A light output from the light source may show a color as it passes through the rotating color wheel. The light that passed through the color wheel is input into the DMD chip. The DMD chip is a component that includes numerous micromirrors. The DMD chip reflects the input light. The projection lens may perform a role of enlarging the light reflected from the DMD chip to an image size.

As still another example, the projection part 170 by the laser method includes a diode pumped solid state (DPSS) laser and a galvanometer. For outputting various colors, DPSS lasers may be provided for each of R, G, and B colors. The galvanometer reflects laser by rotating a mirror quickly by using a motor. For example, the galvanometer may rotate the mirror at 40 KHz/sec at the maximum.

The electronic apparatus 100 may obtain a depth map based on sensing data obtained from the LiDAR sensor 110 or the RGB sensor 140, and obtain information on an area wherein projection is possible in a space based on the obtained depth map. The memory 120 may store information on a plurality of areas wherein projection is possible. Here, an area wherein projection is possible means an area wherein the electronic apparatus 100 can project an image.

An area wherein projection is possible may include not only a wall surface and a bottom, but also an area that can provide an image without disconnection to the user such as an area wherein a screen is installed, a furniture area, a blind area, etc. Also, “information on the plurality of areas wherein projection is possible” may include information on the locations of each of the plurality of areas wherein projection is possible, the planarity of each of the plurality of areas wherein projection is possible, the colors of each of the plurality of areas wherein projection is possible, etc.

The electronic apparatus 100 according to the disclosure may photograph the ambient space of the user and obtain information on the plurality of areas wherein projection is possible. Specifically, the electronic apparatus 100 may control at least one of the LiDAR sensor 110 or the RGB sensor 140 to sense the ambient space, and obtain information on the plurality of areas wherein projection is possible in the ambient space based on the ambient space.

The electronic apparatus 100 may control the projection part 170 to project an image on the areas wherein projection is possible that were obtained based on the ambient space.

Meanwhile, the electronic apparatus 100 may include a moving element 180.

The electronic apparatus 100 may include a moving element 180 in the lower part. The moving element 180 is a component for moving the electronic apparatus 100. For this, the moving element 180 may include a motor, a wheel, etc., and move the electronic apparatus 100 through a movement of the wheel.

If an event that the electronic apparatus 100 should move to a specific location in a space occurs, the electronic apparatus 100 identifies map information for the space from the memory 120, and then sets a moving route to the target location based on the current location. As an example, if it is determined that there is no obstacle on a straight route from the current location to the target location, the electronic apparatus 100 may determine a moving route for moving in a straight line. The electronic apparatus 100 may control the moving element 180 to move the body of the electronic apparatus 100 along the determined moving route. If it is determined that there is an obstacle on the straight route from the current location to the target location, the electronic apparatus 100 may determine an evasive route for evading the obstacle. The electronic apparatus 100 may identify the locations of each obstacle in the space based on the map information, and set an evasive route. Afterwards, the electronic apparatus 100 may control the driving part (not shown) and the moving element 180 to move the body of the electronic apparatus 100 along the evasive route.

According to what is illustrated in FIG. 4, while the moving element 180 was illustrated as a wheel, it may be implemented in the form of a caterpillar in actual implementation, and in case the electronic apparatus 100 is implemented as a drone, etc., it is possible that the moving element 180 is implemented as a propeller, etc.

Meanwhile, in the illustrated example, it was illustrated that the electronic apparatus 100 includes the moving element 180 in itself, but the moving element 180 may be a separate device. For example, the electronic apparatus 100 may be combined with a device that can move such as a robot cleaner, and may be mounted on the robot cleaner and operate by controlling the moving of the robot cleaner.

Meanwhile, the moving element 180 may adjust a projection direction of the electronic apparatus 100. For example, the moving element 180 may adjust a direction which the projection device is toward by adjusting the location of the body of the electronic apparatus 100, or adjust a projection form by adjusting the location of the lens or the mirror in the projection device.

Here, the projection direction means a direction in which an image in a projection form is projected, and may be referred to as a direction which the electronic apparatus 100 is toward, a projection direction, etc. Hereinafter, it will be expressed that the projection direction is changed for easy explanation, but it may also be expressed that the projection area is changed. Here, change of the projection area means a case wherein the center point of the projection area is changed, but not a case wherein the screen size is changed while the center point of the projection area is maintained.

However, the components of the moving element 180 are merely one of various embodiments, and the components of the moving element 180 may be omitted. For example, the electronic apparatus 100 may be a movable projector that includes the moving element 180 in itself, or a movable projector that the user should carry and move without the moving element 180.

In case the electronic apparatus 100 does not include the moving element 180, the electronic apparatus 100 may sense the ambient space in the location arranged by the user and obtain sensing data, and project an image in an area wherein projection is possible that was obtained based on the obtained sensing data.

Meanwhile, the electronic apparatus 100 may additionally include some components that were not illustrated in FIG. 13.

For example, the electronic apparatus 100 may include a microphone for receiving a user voice. The microphone may transmit a received user voice to the electronic apparatus 100. Then, the electronic apparatus 100 may input the received user voice into a voice recognition model and perform voice recognition. For example, the electronic apparatus 100 may perform voice recognition for the user voice by performing Speech to Text (STT) for the user voice. The microphone may receive a user voice, and transmit the received user voice to the electronic apparatus 100. Then, the electronic apparatus 100 may perform voice recognition by inputting the received user voice into the voice recognition model. For example, the electronic apparatus 100 may perform voice recognition for the user voice by performing Speech to Text (STT) for the user voice.

According to an embodiment of the disclosure, if the electronic apparatus 100 receives a user voice for moving the electronic apparatus 100 to a new space through the microphone, the one electronic apparatus 100 may control the driving part (not shown) and the moving element 180 to move to a location wherein the electronic apparatus 100 can sense a space. However, the disclosure is not limited thereto.

As an example, as such a user voice, an analog voice signal may be input into a microphone of an external device such as a remote control, etc. other than a case wherein the electronic apparatus 100 includes a microphone. The remote control, etc. may digitalize the analog voice signal and transmit the signal to the electronic apparatus 100. However, the disclosure is not limited thereto.

As an example, based on a user voice input through a microphone included in a smartphone, the user may remotely control the electronic apparatus 100 through the smartphone. Specifically, a smartphone may perform a voice recognition function through an installed remote control application. However, an external device performing a voice recognition function and a remote control function as above is not limited such that these functions are performed only by a smartphone, but the same functions may be performed through an electronic apparatus wherein an AI speaker equipped with a voice recognition function and other applications can be installed.

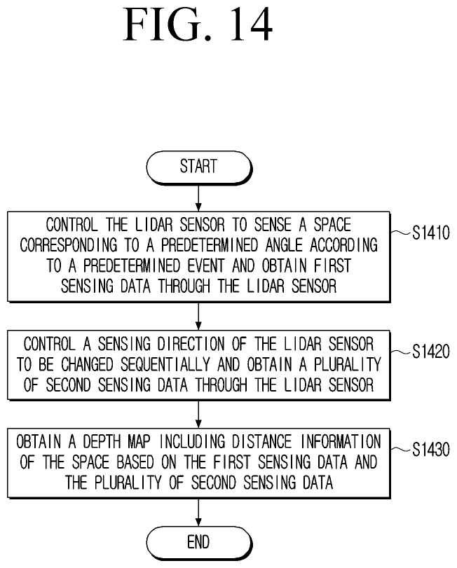

FIG. 14 is a flow chart for illustrating a controlling method of an electronic apparatus according to at least one embodiment of the disclosure.

According to FIG. 14, the electronic apparatus 100 may control the LiDAR sensor to sense a space with a sensing direction corresponding to a predetermined angle according to a predetermined event and obtain first sensing data through the LiDAR sensor in the step S1410. As the predetermined event and the predetermined angle were explained in the aforementioned various embodiments, overlapping explanation will be omitted.

Then, the sensing direction of the LiDAR sensor may be controlled to be changed sequentially and a plurality of second sensing data may be obtained through the LiDAR sensor in the step S1420. As a sensing direction of the LiDAR sensor, etc. was explained in the aforementioned various embodiments, overlapping explanation will be omitted.

Then, a depth map including distance information of the space may be obtained based on the first sensing data and the plurality of second sensing data in the step S1430. Then, distance information of object areas may be identified based on the first sensing data, the plurality of second sensing data, and third sensing data obtained by an RGB sensor. As an operation of updating distance information included in a depth map based on the distance information of the object areas was explained in the aforementioned various embodiments, overlapping explanation will be omitted.

The controlling method in FIG. 14 may be performed by an electronic apparatus having a configuration as in FIG. 2 or FIG. 11, but is not necessarily limited thereto, and the controlling method may be performed by an apparatus having a different configuration.

Also, each of the aforementioned various embodiments may be implemented solely, or may be implemented by being combined with the various other embodiments of the disclosure on the whole or partially.

Meanwhile, methods according to the aforementioned various embodiments of the disclosure may be implemented just with software upgrade, or hardware upgrade for a conventional electronic apparatus.

In addition, it is also possible that the aforementioned various embodiments of the disclosure are performed through an embedded server provided on an electronic apparatus, or an external server of an electronic apparatus.

Meanwhile, according to an embodiment of the disclosure, the aforementioned various embodiments may be implemented as software including instructions stored in machine-readable storage media, which can be read by machines (e.g.: computers). In case software or a program as above is performed by an electronic apparatus, the electronic apparatus may perform the various controlling methods as explained in the aforementioned various embodiments.

Software or a program as above may be used while being stored in a non-transitory computer-readable medium. Here, the term ‘non-transitory’ only means that a storage medium does not include a signal, and is tangible, and does not distinguish a case wherein data is stored in the storage medium semi-permanently and a case wherein data is stored temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an on-line application store. In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned various embodiments (e.g.: a module or a program) may consist of a singular object or a plurality of objects, and some sub components among the aforementioned corresponding sub components may be omitted, or other sub components may be further included in the various embodiments. Alternatively or additionally, some components (e.g.: a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
a LiDAR sensor; and
at least one processor configured to:
based on occurrence of a predetermined event, control the LiDAR sensor to sense a space with a sensing direction of the LiDAR sensor corresponding to a predetermined angle, so that the LiDAR sensor thereby obtains first sensing data,
after controlling the LiDAR sensor to sense the space with the sensing direction of the LiDAR sensor corresponding to the predetermined angle, control the sensing direction of the LiDAR sensor to be changed sequentially so that the LiDAR sensor thereby obtains a plurality of second sensing data respectfully corresponding to the sequentially changed sensing direction, and
obtain a depth map including distance information of the space based on the first sensing data and the plurality of second sensing data.

2. The electronic apparatus of claim 1, wherein the predetermined angle is a parallel angle with a ground.

3. The electronic apparatus of claim 2, wherein the predetermined event is an activation of the electronic apparatus.

4. The electronic apparatus of claim 1, further comprising:
an RGB sensor,
wherein the at least one processor is configured to:
control the RGB sensor to obtain third sensing data in an environment of the electronic apparatus,
identify a plurality of object areas based on the third sensing data,
identify distance information of the plurality of object areas based on the distance information included in the depth map, and
update the distance information included in the depth map based on the identified distance information of the plurality of object areas.

5. The electronic apparatus of claim 4, wherein the at least one processor is configured to:
identify areas corresponding to each of the plurality of object areas in the depth map, and
update the areas corresponding to each of the plurality of object areas in the depth map with same distance information.

6. The electronic apparatus of claim 4, wherein the at least one processor is configured to:
obtain information on a vanishing point identified based on the plurality of object areas, and
update the distance information included in the depth map based on the obtained information on the vanishing point.

7. The electronic apparatus of claim 4, wherein the at least one processor is configured to:
process the first sensing data, the plurality of second sensing data, and the third sensing data so as to have matching view points, and
with the view points being matched, update the distance information included in the depth map based on the first sensing data, the plurality of second sensing data, and the third sensing data.

8. The electronic apparatus of claim 1, wherein the at least one processor is configured to:
obtain information on a vanishing point based on the first sensing data and the plurality of second sensing data, and
update the distance information included in the depth map based on the obtained information on the vanishing point.

9. The electronic apparatus of claim 1, wherein, to control the sensing direction of the LiDAR sensor to be sequentially changed, the at least one processor is configured to:
while a range of a left to right sensing direction of the LiDAR sensor is in a predetermined angle range, control the sensing direction of the LiDAR sensor to be sequentially changed in an up to down direction.

10. A controlling method of an electronic apparatus that includes a LiDAR sensor, the controlling method comprising:
based on occurrence of a predetermined event, controlling the LiDAR sensor to sense a space with a sensing direction of the LiDAR sensor corresponding to a predetermined angle, so that the LiDAR sensor thereby obtains first sensing data;
after controlling the LiDAR sensor to sense the space with the sensing direction of the LiDAR sensor corresponding to the predetermined angle, controlling the sensing direction of the LiDAR sensor to be changed sequentially so that the LiDAR sensor thereby obtains a plurality of second sensing data respectfully corresponding to the sequentially changed sensing direction; and
obtaining a depth map including distance information of the space based on the first sensing data and the plurality of second sensing data.

11. The controlling method of claim 10, wherein the predetermined angle is a parallel angle with a ground.

12. The controlling method of claim 11, wherein the predetermined event is an activation of the electronic apparatus.

13. The controlling method of claim 10, wherein
the electronic apparatus further includes an RGB sensor, and
the controlling method further comprises:
controlling the RGB sensor to obtain third sensing data in an environment of the electronic apparatus;
identifying a plurality of object areas based on the third sensing data;
identifying distance information of the plurality of object areas based on the distance information included in the depth map; and
updating the distance information included in the depth map based on the identified distance information of the plurality of object areas.

14. The controlling method of claim 13, further comprising:
identifying areas corresponding to each of the plurality of object areas in the depth map; and
updating the areas corresponding to each of the plurality of object areas in the depth map with same distance information.

15. A non-transitory computer-readable recording medium storing computer instructions which, when executed by a processor of an electronic apparatus that includes a LiDAR sensor, cause the electronic apparatus to perform operations comprising:
based on occurrence of a predetermined event, controlling the LiDAR sensor to sense a space with a sensing direction of the LiDAR sensor corresponding to a predetermined angle, so that the LiDAR sensor thereby obtains first sensing data;
after controlling the LiDAR sensor to sense the space with the sensing direction of the LiDAR sensor corresponding to the predetermined angle, controlling the sensing direction of the LiDAR sensor to be changed sequentially so that the LiDAR sensor thereby obtains a plurality of second sensing data respectively corresponding to the sequentially changed sensing direction; and
obtaining a depth map including distance information of the space based on the first sensing data and the plurality of second sensing data.
